(19) United States
(12) Patent Application Publication
(10) Pub. No.: US 2023/0289674 A1
(43) Pub. Date: Sep. 14, 2023

(54) COMPUTER-READABLE RECORDING MEDIUM STORING CONTROL PROGRAM, CONTROL METHOD, AND INFORMATION PROCESSING APPARATUS

(71) Applicant: Fujitsu Limited, Kawasaki-shi (JP)

(72) Inventor: Hayato NISHIMURA, Funabashi (JP)

(73) Assignee: Fujitsu Limited, Kawasaki-shi (JP)

(21) Appl. No.: 18/156,608

(22) Filed: Jan. 19, 2023

(30) Foreign Application Priority Data
Mar. 11, 2022 (JP) 2022-037698

(51) Int. Cl. G06Q 10/0631; G06F 18/24; G06F 18/22

(52) U.S. Cl. CPC G06Q 10/063112; G06F 18/24; G06F 18/22

(57) ABSTRACT

A computer-readable recording medium storing a program for causing a computer to execute processing including: acquiring browsing feature information indicating a feature of a browsed sentence from browsed data indicating the browsed sentence browsed by a user; acquiring posting feature information indicating a feature of a posted sentence from posted data indicating the posted sentence posted by the user; acquiring target feature information indicating a feature of a target sentence from each target sentence as a processing target; calculating a similarity degree of the target feature information to a set of the browsing feature information and the posting feature information by assigning a larger weight to the posting feature information than to the browsing feature information for each target sentence; and determining a priority of each target sentence to be presented to the user as the processing target, based on the similarity degree of each target sentence.

### CROSS-REFERENCE TO RELATED APPLICATION

This application is based upon and claims the benefit of priority of the prior Japanese Patent Application No. 2022-37698, filed on Mar. 11, 2022, the entire contents of which are incorporated herein by reference.

### FIELD

The embodiment discussed herein are related to a computer-readable recording medium storing a control program, a control method, and an information processing apparatus.

### BACKGROUND

For a sentence described in a natural language, setting work of information on the content of the sentence may be manually performed. Such work is referred to as annotation work. For example, in a case where supervised machine learning is performed, annotation work is performed in order to create training data. For example, labels indicating the contents of a large number of sentences (text) are assigned to the sentences in the annotation work.

Knowledge of a target field may be desired for annotation work on a sentence in some cases. In such a case, it is preferable that the annotation be performed by a worker who may correctly understand the description contents. For example, in a case where a tag is assigned to a named entity of a chemical substance in a sentence, in a case where an implication relationship to a software development document is assigned, or the like, sufficient knowledge related to a target field is desired. For this purpose, it is important to accurately understand which field the worker has a lot of knowledge about.

As a technique of estimating an attribute such as an interest of a user, for example, a user attribute estimation method has been proposed which makes it possible to obtain a user attribute estimator for accurately estimating user attribute information of a user. A guide device has also been proposed which provides a guide device that is easier to operate for various users by changing the manner of changing the output content in accordance with the skill level of each user in a case of changing the content to be guided to the user.

Japanese Laid-open Patent Publication No. 2014-153934 and Japanese Laid-open Patent Publication No. 2018-124938 are disclosed as related art.

### SUMMARY

According to an aspect of the embodiments, there is provided a computer-readable recording medium storing a program for causing a computer to execute processing including: acquiring browsing feature information indicating a feature of a browsed sentence from browsed data indicating the browsed sentence that is browsed by a user; acquiring posting feature information indicating a feature of a posted sentence from posted data indicating the posted sentence that is posted by the user; acquiring target feature information indicating a feature of a target sentence from each of a plurality of target sentences as a processing target; calculating a similarity degree of the target feature information to a set of the browsing feature information and the posting feature information by assigning a larger weight to the posting feature information than to the browsing feature information for each of the plurality of target sentences; and determining a priority of each of the plurality of target sentences to be presented to the user as the processing target, based on the similarity degree of each of the plurality of target sentences.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a control method according to a first embodiment;

FIG. 2 is a diagram illustrating an example of a system configuration;

FIG. 3 is a diagram illustrating an example of hardware of an annotation server;

FIG. 4 is a diagram illustrating an example of annotation work;

FIG. 5 is a block diagram illustrating an example of functions of each device for annotation work support;

FIG. 6 is a diagram illustrating an example of a browsing and posting log stored in a log storage unit;

FIG. 7 is a diagram illustrating an example of feature word acquisition processing;

FIG. 8 is a diagram illustrating an example of question sentence feature word acquisition processing;

FIG. 9 is a diagram illustrating an example of similarity degree calculation processing;

FIG. 10 is a diagram illustrating a first calculation example of a browsing similarity degree;

FIG. 11 is a diagram illustrating a second calculation example of a browsing similarity degree;

FIG. 12 is a diagram illustrating a calculation example of a posting similarity degree;

FIG. 13 is a diagram illustrating a calculation example of a similarity degree to a full knowledge field of a worker;

FIG. 14 is a diagram illustrating a difference in a similarity degree between presence and absence of weighting;

FIG. 15 illustrates a first half of a flowchart illustrating a procedure of annotation support processing;

FIG. 16 illustrates a latter half of the flowchart illustrating the procedure of the annotation support processing;

FIG. 17 illustrates a flowchart illustrating an example of a procedure of feature word acquisition processing;

FIG. 18 is a diagram illustrating an example of an annotation work screen;

FIG. 19 is a diagram illustrating an example of label assignment processing to a predetermined portion of a question sentence;

FIG. 20 is a diagram illustrating an example of similarity degree calculation processing using a posting log of a Q&A site;

FIG. 21 illustrates a first half of a flowchart illustrating a procedure of annotation support processing in a third embodiment; and

FIG. 22 illustrates a latter half of the flowchart illustrating the procedure of the annotation support processing in the third embodiment.

### DESCRIPTION OF EMBODIMENTS

As a countermeasure for reducing a load of an intelligent work such as manual annotation work, for example, it is considered to present a sentence having contents corresponding to knowledge of a worker to the worker as a processing target. In a case where a sentence related to a field in which a worker has sufficient knowledge may be presented to the worker as a processing target, a work load may be reduced. By presenting a sentence related to a field in which the worker has sufficient knowledge, it is also possible to obtain a high-quality work result. However, in the related art, it is not possible to determine with sufficient accuracy which sentence has contents corresponding to a field to which a worker is skilled. For this reason, it is difficult to present a sentence as the processing target in an appropriate order.

According to one aspect, an object of the present disclosure is to present a sentence as a processing target in an appropriate order.

Hereinafter, embodiments will be described with reference to the drawings. A plurality of embodiments may be implemented in combination within a range without contradiction.

### First Embodiment

There is a control method of a processing target sentence for presenting a plurality of processing target sentences to be processed by a user, as processing targets in an appropriate order according to knowledge of the user.

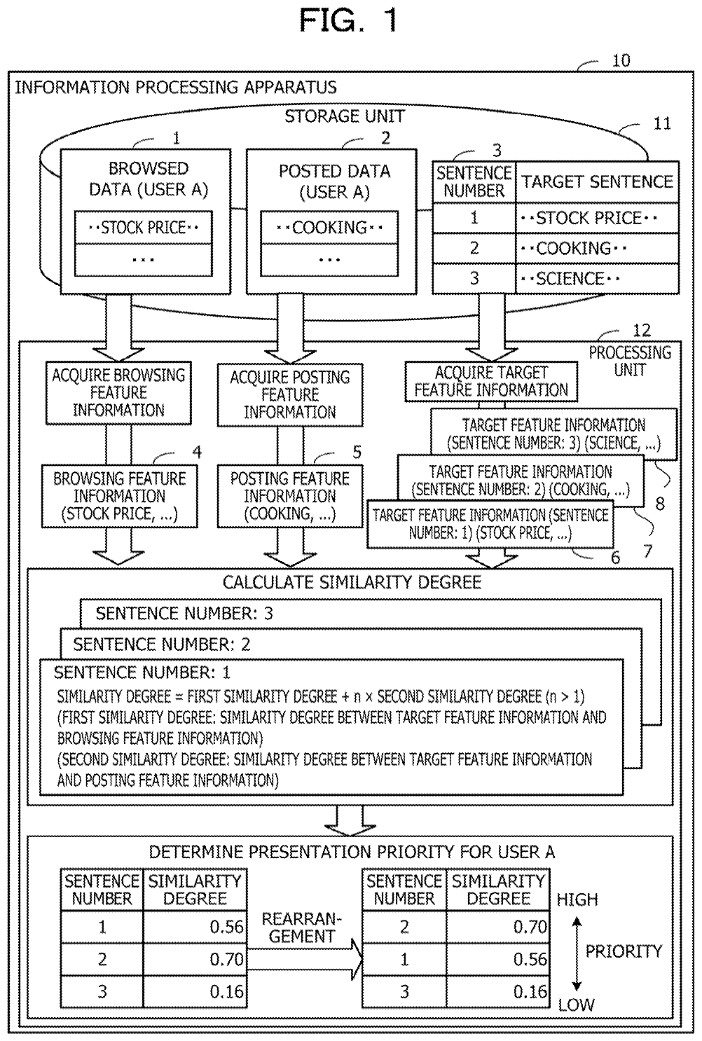

FIG. 1 is a diagram illustrating an example of a control method according to a first embodiment. FIG. 1 illustrates an information processing apparatus 10 for implementing the control method. The information processing apparatus 10 may implement the control method by executing a control program, for example.

The information processing apparatus 10 includes a storage unit 11 and a processing unit 12. The storage unit 11 is, for example, a storage device or a memory included in the information processing apparatus 10. The processing unit 12 is, for example, a processor or an arithmetic circuit included in the information processing apparatus 10.

The storage unit 11 stores browsed data 1, posted data 2, and target sentence data 3. The browsed data 1 is data indicating a browsed sentence browsed by the user who performs work (“user A” in the example illustrated in FIG. 1). The posted data 2 is data indicating a posted sentence posted by the user who performs work. The target sentence data 3 is data including a plurality of target sentences as the processing target. For example, a sentence number is assigned to the target sentence, and the target sentence is identified by the sentence number.

By comparing the browsed data 1 and the posted data 2 with each of the plurality of target sentences in the target sentence data 3, the processing unit 12 preferentially presents, to the user, among the plurality of target sentences, a target sentence having a content similar to a field that the user performing the work is fully aware of. For this reason, the processing unit 12 executes the following processing.

The processing unit 12 acquires browsing feature information 4 indicating a feature of the browsed sentence from the browsed data 1. For example, the processing unit 12 generates the browsing feature information 4 including a feature word or phrase included in the browsed sentence. In the example illustrated in FIG. 1, a word or phrase “stock price” is included in the browsed sentence, and the browsing feature information 4 including this word or phrase is generated.

The processing unit 12 acquires posting feature information 5 indicating a feature of the posted sentence from the posted data 2. For example, the processing unit 12 generates the posting feature information 5 including a feature word or phrase included in the posted sentence. In the example illustrated in FIG. 1, a word or phrase “cooking” is included in the posted sentence, and the posting feature information 5 including this word or phrase is generated.

The processing unit 12 acquires target feature information 6 to 8 indicating features of the target sentences from the plurality of respective target sentences as the processing target. For example, the processing unit 12 generates the target feature information 6 to 8 including the feature words or phrases included in the target sentences. In the example illustrated in FIG. 1, the word or phrase “stock price” is included in the target sentence having a sentence number “1”, and the target feature information 6 including this word or phrase is generated. The word or phrase “cooking” is included in the target sentence having a sentence number “2”, and the target feature information 7 including this word or phrase is generated. A word or phrase “science” is included in the target sentence having a sentence number “3”, and the target feature information 8 including this word or phrase is generated.

For each of the plurality of target sentences, the processing unit 12 assigns a larger weight to the posting feature information 5 than to the browsing feature information 4, and calculates the similarity degree of the target feature information 6 to 8 to a set of the browsing feature information 4 and the posting feature information 5. For example, the processing unit 12 calculates a first similarity degree indicating the similarity degree between the target feature information 6 to 8 and the browsing feature information 4. The processing unit 12 calculates a second similarity degree indicating the similarity degree between the target feature information 6 to 8 and the posting feature information 5. The processing unit 12 sets a sum of a value obtained by multiplying the second similarity degree by a coefficient n indicating a weight and the first similarity degree, as the similarity degree of the target sentence. The coefficient n indicating the weight is a real number larger than 1.

In a case where each of the browsing feature information 4, the posting feature information 5, and the target feature information 6 to 8 includes a feature word or phrase of the original sentence, the processing unit 12 may calculate the first similarity degree and the second similarity degree based on commonality of the feature word or phrase, for example. For example, the processing unit 12 calculates the first similarity degree based on the commonality of the word or phrase included in the target feature information 6 to 8 and the browsing feature information 4. The processing unit 12 calculates the second similarity degree based on the commonality of the word or phrase included in the target feature information 6 to 8 and the posting feature information 5.

In the example illustrated in FIG. 1, the target feature information 6 having the sentence number “1” has the word or phrase “stock price” in common with the browsing feature information 4. In a case where there is no word or phrase common to the target feature information 6 and the posting feature information 5, the first similarity degree is higher than the second similarity degree for the target feature information 6. The target feature information 7 having the sentence number “2” has the word or phrase “cooking” in common with the posting feature information 5. In a case where there is no word or phrase common to the target feature information 7 and the browsing feature information 4, the second similarity degree is higher than the first similarity degree for the target feature information 7. In the calculation of the final similarity degree, since a large weight is assigned to the second similarity degree, the similarity degree of the target sentence having the sentence number “2” is larger than the similarity degree of the target sentence having the sentence number “1”.

Based on the similarity degree of each of the plurality of target sentences, the processing unit 12 determines the priority of each of the plurality of target sentences to be presented to the user as the processing target. For example, the processing unit 12 rearranges the target sentences based on the similarity degree, and gives a higher priority for the presentation to the user, to the target sentence at a higher level after the rearrangement (target sentence having a higher similarity degree).

As described above, it is possible to preferentially present, as the processing target by the user, the target sentence having a content similar to a field that the user is fully aware of. For example, although the features of the field in which the user is interested are known only by the browsed data 1, it is not possible to determine whether or not the user has familiar knowledge of the field. Since the posted data 2 includes information of a field in which the user may explain the knowledge to others, it is possible to extract features of a field in which the user has familiar knowledge by using the posted data 2. In this case, in a case where the browsed data 1 and the posted data 2 are treated equally, in a case where there are many browsed sentences of a field in which the user does not have deep knowledge, there is a possibility that the similarity degree of a target sentence in the field is higher than the similarity degree of other target sentences. By weighting such that the feature of the posted sentence indicated in the posted data 2 is strongly reflected in the similarity degree, it is possible to increase the priority order of the presentation of the target sentence having a content in a field that the user is fully aware of.

It is possible to determine the similarity degree of the target sentence only by the browsed data 1 and the posted data 2 related to the user who performs the work, without performing relative comparison with other users. Therefore, it is possible to obtain the similarity degree of the target sentence as an absolute value of the user who performs the work, and the obtained similarity degree is a value with high reliability that does not depend on an action such as browsing of another user.

By multiplying the second similarity degree by the coefficient as the weighting, it is possible to easily set the magnitude of the weight by the value of the coefficient. For example, in a case where the work performed by the user is work performed by a person having very deep knowledge about the content of the target sentence, the value of the coefficient indicating the weight may be increased to reduce the influence of the browsed data 1.

By using a word or phrase indicating a feature as the information indicating a feature of each sentence, it is possible to calculate a similarity degree based on the commonality of the word or phrase. Accordingly, it is easy to calculate an appropriate similarity degree.

The posted sentence indicated in the posted data 2 may include a posted sentence for asking another user about something and a posted sentence for giving an answer to a question of another user. The processing unit 12 may calculate the similarity degree by assigning a larger weight to the feature of the posted sentence for an answer than to the feature of the posted sentence for a question.

For example, the processing unit 12 classifies posted sentences into a first posted sentence for positing a question and a second posted sentence for posting an answer. Next, the processing unit 12 acquires first posting feature information indicating a feature of the first posted sentence and second posting feature information indicating a feature of the second posted sentence. The processing unit 12 assigns a larger weight to the second posting feature information than to the first posting feature information, and calculates the similarity degree of the target sentence.

For a field indicated by the posted sentence for a question by the user, it is considered that the user has a willingness to obtain knowledge but does not have sufficient knowledge. By contrast, for a field indicated by the posted sentence for an answer by the user, it is considered that the user already has knowledge enough to explain knowledge that another user does not know. By assigning a larger weight to the feature of the posted sentence for an answer than to the feature of the posted sentence for a question, it is possible to increase the similarity degree related to the target sentence similar to the field of knowledge that the user has. As a result, the target sentence may be presented to the user in a more appropriate order.

A posted sentence selected as a good answer by another user may be included in the posted sentence for an answer. The processing unit 12 may calculate the similarity degree by assigning a larger weight to the feature of the posted sentence for an answer which is the good answer, than to the feature of the posted sentence for an answer other than the good answer.

For example, the processing unit 12 classifies posted sentences for posting answers to a question into a third posted sentence for posting an answer that is not selected as a good answer and a fourth posted sentence for posting an answer selected as a good answer. The processing unit 12 acquires third posting feature information indicating a feature of the third posted sentence and fourth posting feature information indicating a feature of the fourth posted sentence. The processing unit 12 assigns a larger weight to the fourth posting feature information than to the third posting feature information, and calculates the similarity degree of the target sentence.

The user who has posted a posted sentence for an answer, which is selected as a good answer by another user, is considered to be more knowledgeable about the field indicated in the content of the posted sentence than many other users. For this reason, by assigning a larger weight to the feature of the posted sentence for an answer which is the good answer than to the feature of the posted sentence for an answer other than the good answer, it is possible to more strongly reflect the feature of the field that the user having posted the good answer is fully aware of, in the calculation of the similarity degree. As a result, the target sentence may be presented to the user in a more appropriate order.

### Second Embodiment

A second embodiment is a system that supports annotation work so as to efficiently perform the annotation work on training data of machine learning. Hereinafter, a sentence (text) as an annotation target is referred to as a question sentence.

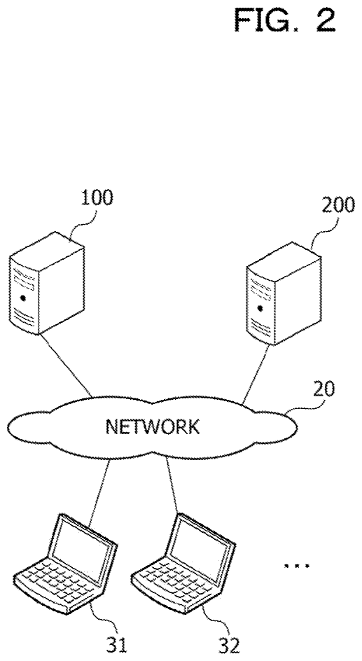

FIG. 2 is a diagram illustrating an example of a system configuration. An annotation server 100, a communication server 200, and a plurality of terminals 31, 32, and the like are coupled to each other via a network 20 in a system that supports annotation work.

The annotation server 100 is a computer that supports annotation work on a question sentence. The communication server 200 is a computer that supports online communication between users. The terminals 31, 32, and the like are computers used by other users or workers performing annotation work.

The annotation server 100 presents a question sentence corresponding to a field that the worker is fully aware of, as the annotation target to the worker. In this case, the annotation server 100 obtains the similarity degree of the question sentence to the field in which the worker has knowledge, as an absolute value instead of a relative value to other workers. For example, the annotation server 100 acquires information on the knowledge of the worker from the communication server 200, and calculates a similarity degree between a field described in the question sentence and a field in which the worker has knowledge, based on the similarity degree between the acquired information and the question sentence. In this case, the annotation server 100 reflects not only the “interest” of the worker but also detailed “knowledge” of the worker as the knowledge of the worker. It is possible to reduce the work load of the worker by presenting such a question sentence in a field that the worker is fully aware of, as a question sentence of the annotation work target.

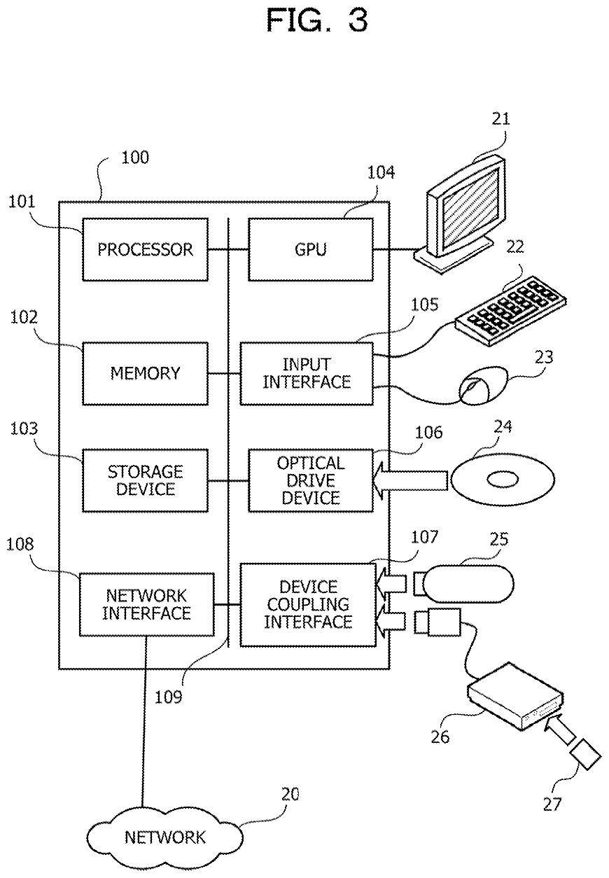

FIG. 3 is a diagram illustrating an example of hardware of the annotation server. The annotation server 100 is entirely controlled by a processor 101. A memory 102 and multiple peripheral devices are coupled to the processor 101 via a bus 109. The processor 101 may be a multiprocessor. The processor 101 is, for example, a central processing unit (CPU), a microprocessor unit (MPU), or a digital signal processor (DSP). At least part of functions implemented by the processor 101 executing a program may be implemented by an electronic circuit such as an application-specific integrated circuit (ASIC) or a programmable logic device (PLD).

The memory 102 is used as a main storage device of the annotation server 100. The memory 102 temporarily stores at least part of an operating system (OS) program or an application program to be executed by the processor 101. The memory 102 stores various types of data to be used for processing by the processor 101. As the memory 102, for example, a volatile semiconductor storage device such as a random-access memory (RAM) is used.

The peripheral devices coupled to the bus 109 include a storage device 103, a graphics processing unit (GPU) 104, an input interface 105, an optical drive device 106, a device coupling interface 107, and a network interface 108.

The storage device 103 writes and reads data electrically or magnetically to a built-in recording medium. The storage device 103 is used as an auxiliary storage device of the annotation server 100. The storage device 103 stores the OS program, the application programs, and various types of data. As the storage device 103, for example, a hard disk drive (HDD) or a solid-state drive (SSD) may be used.

The GPU 104 is an arithmetic device that performs image processing, and is also referred to as a graphic controller. A monitor 21 is coupled to the GPU 104. The GPU 104 displays images on a screen of the monitor 21 in accordance with an instruction from the processor 101. As the monitor 21, a display device using organic electro luminescence (EL), a liquid crystal display device, or the like is used.

A keyboard 22 and a mouse 23 are coupled to the input interface 105. The input interface 105 transmits signals transmitted from the keyboard 22 and the mouse 23, to the processor 101. The mouse 23 is an example of a pointing device, and other pointing devices may be used. Examples of the other pointing devices include a touch panel, a tablet, a touch pad, a track ball, and the like.

The optical drive device 106 reads data recorded in an optical disk 24 or writes data to the optical disk 24 by using laser light or the like. The optical disk 24 is a portable-type recording medium in which data is recorded in a manner readable through reflection of light. Examples of the optical disk 24 include a Digital Versatile Disc (DVD), a DVD-RAM, a compact disc read-only memory (CD-ROM), a CD-recordable (CD-R), a CD-rewritable (CD-RW), and the like.

The device coupling interface 107 is a communication interface for coupling a peripheral device to the annotation server 100. For example, a memory device 25 and a memory reader/writer 26 may be coupled to the device coupling interface 107. The memory device 25 is a recording medium equipped with a function of communication with the device coupling interface 107. The memory reader/writer 26 is a device that writes data to a memory card 27 or reads data from the memory card 27. The memory card 27 is a card-type recording medium.

The network interface 108 is coupled to the network 20. The network interface 108 transmits and receives data to and from another computer or communication device via the network 20. The network interface 108 is, for example, a wired communication interface that is coupled to a wired communication device such as a switch or a router, by a cable. The network interface 108 may be a wireless communication interface that is coupled to a wireless communication device such as a base station or an access point for communication through radio waves.

With the hardware described above, the annotation server 100 may implement processing functions of the second embodiment. The information processing apparatus 10 described in the first embodiment may also be implemented by the same hardware as the annotation server 100 illustrated in FIG. 3.

The annotation server 100 implements the processing functions of the second embodiment by executing a program recorded in a computer-readable recording medium, for example. A program in which the contents of processing to be executed by the annotation server 100 are written may be recorded in various recording media. For example, a program to be executed by the annotation server 100 may be stored in the storage device 103. The processor 101 loads at least part of the program in the storage device 103 to the memory 102, and executes the program. The program to be executed by the annotation server 100 may also be recorded in a portable-type recording medium such as the optical disk 24, the memory device 25, and the memory card 27. The program stored in the portable-type recording medium is made executable after the program is installed in the storage device 103 under the control of the processor 101, for example. The processor 101 may read the program directly from the portable-type recording medium and execute the program.

By using such a system, a worker may perform annotation work. For example, the worker uses a terminal 31 to access the annotation server 100 and perform the annotation work.

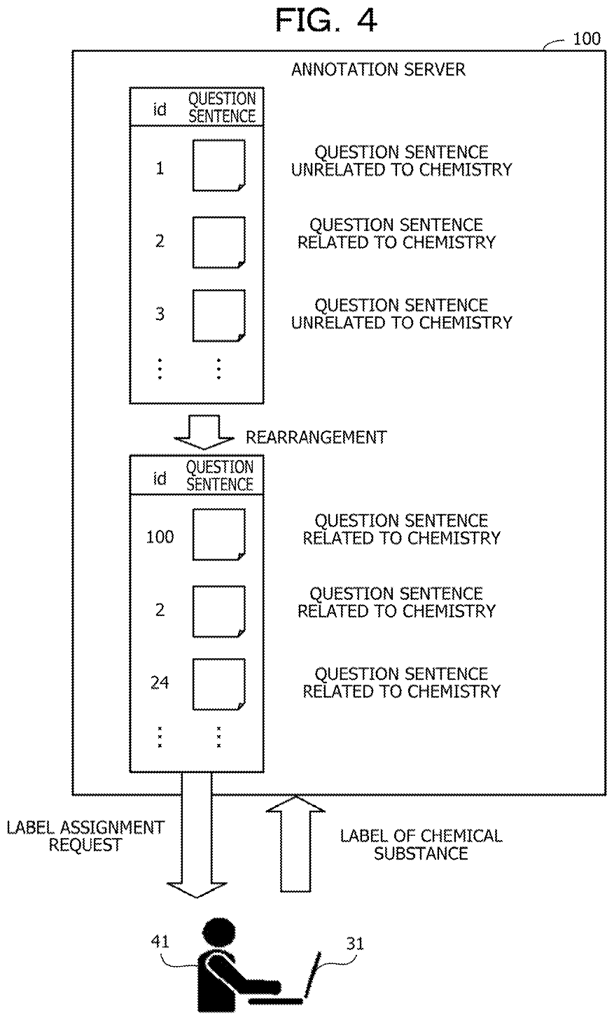

FIG. 4 is a diagram illustrating an example of annotation work. In the example illustrated in FIG. 4, it is assumed that a worker 41 who performs the annotation work has rich knowledge about chemistry. In this case, the worker 41 operates the terminal 31 to request the annotation server 100 to present a question sentence as the annotation target. The annotation server 100 rearranges a plurality of question sentences as the annotation target such that the question sentence related to chemistry is at a higher level. The annotation server 100 transmits the question sentences as the annotation target to the terminal 31 in order from the question sentence at a higher level. The transmitted question sentence is displayed on the screen of the terminal 31.

The worker 41 checks the content of the question sentence displayed on the screen of the terminal 31, and performs an operation input for labeling the question sentence on the terminal 31. The terminal 31 transmits the question sentence to which a label is assigned, to the annotation server 100. The annotation work is performed in this manner. At this time, the annotation server 100 preferentially presents the question sentence corresponding to the knowledge of the worker 41 as the target of the annotation work. For this reason, the annotation server 100 determines the field that the worker 41 is fully aware of, based on a usage status of the communication server 200 by the worker 41.

For example, the annotation server 100 uses “interest” of the worker and “knowledge” that the worker may teach, as determination elements of a field that the worker 41 is fully aware of. The annotation server 100 estimates “interest” of the worker 41 from a browsing log of the worker 41, and estimates “knowledge” that the worker may teach from a posting log of the worker. For example, it may be considered that the posted content strongly reflects a field that the worker is fully aware of, compared with the browsed content of the worker. The annotation server 100 assigns a weight to the posting log as compared with the browsing log, and uses the weighted posting log for calculating the similarity degree between information indicating the field that the worker is fully aware of and the question sentence.

A reason why it may be considered that the field that the worker is fully aware of is strongly reflected in the posted content is as follows. For example, attention is paid to a personal vocabulary. A vocabulary set (active vocabulary) that may be used when an individual speaks or writes is smaller than a vocabulary set (passive vocabulary) that the individual may understand. Compared with the passive vocabulary of the worker, the active vocabulary of the worker is a result of actual operation. From these facts, it may be considered that the knowledge of the worker is more reflected in the active vocabulary of the worker.

The annotation server 100 calculates the similarity degree between the field that the worker is fully aware of and the question sentence on the assumption that the browsing activity of the worker is directed to a field of interest and the posting activity of the worker is directed to a field of knowledge. The annotation server 100 preferentially presents a question sentence having a high similarity degree to a field that the worker is fully aware of, as a question sentence of the annotation work target of the worker.

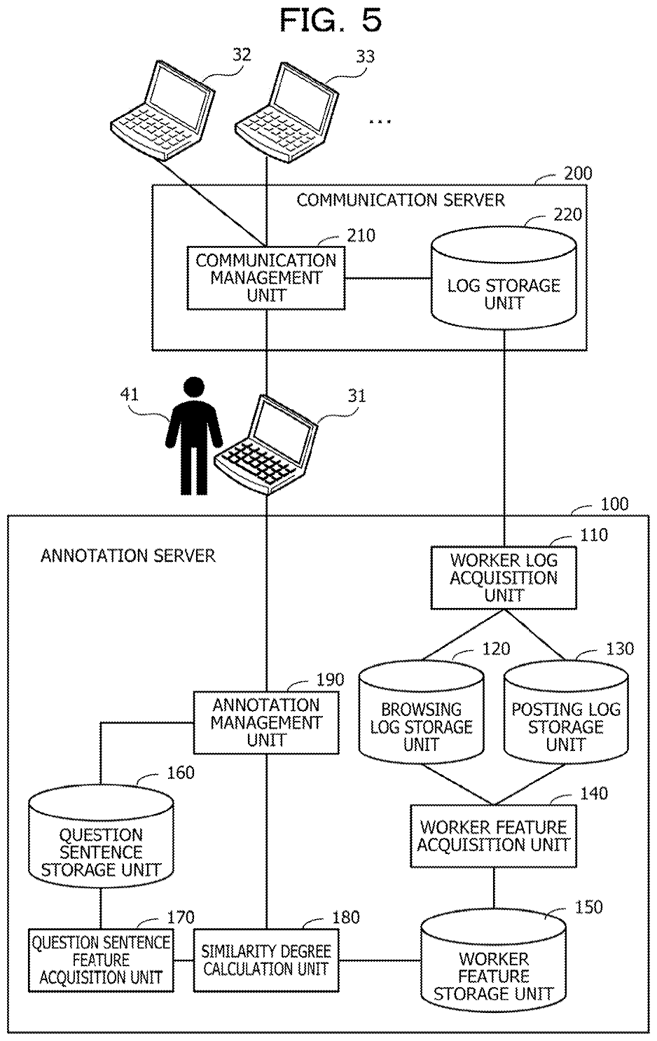

FIG. 5 is a block diagram illustrating an example of functions of each device for annotation work support. The communication server 200 includes a communication management unit 210 and a log storage unit 220. The communication management unit 210 provides a place for the worker 41 and other users to communicate online by using the terminals 31, 32, 33, and the like. For example, the communication management unit 210 provides a service such as a bulletin board site or a question and answer (Q&A) site. In a case where there is a post from the user, the communication management unit 210 stores the posted content in the log storage unit 220. In a case where information is browsed by the user, the communication management unit 210 stores the content of the browsed information in the log storage unit 220.

The log storage unit 220 stores the posted contents and the browsed contents of each of a plurality of users. For example, in a case where the user name of the worker 41 is “user A”, the sentence posted by the worker 41 (posting log) and the sentence browsed by the worker 41 (browsing log) are stored in the log storage unit 220 in association with the user name “user A”.

The annotation server 100 includes a worker log acquisition unit 110, a browsing log storage unit 120, a posting log storage unit 130, a worker feature acquisition unit 140, a worker feature storage unit 150, a question sentence storage unit 160, a question sentence feature acquisition unit 170, a similarity degree calculation unit 180, and an annotation management unit 190.

The worker log acquisition unit 110 acquires a posting log and a browsing log of the worker 41 from the communication server 200. The worker log acquisition unit 110 stores the acquired browsing log in the browsing log storage unit 120. The worker log acquisition unit 110 stores the acquired posting log in the posting log storage unit 130. The browsing log storage unit 120 stores a browsing log of the worker 41. The posting log storage unit 130 stores a posting log of the worker 41.

The worker feature acquisition unit 140 acquires features of the knowledge of the worker 41 based on the browsing log and the posting log of the worker 41. For example, the worker feature acquisition unit 140 extracts a feature word from the contents of the browsing log and the posting log of the worker. The feature word is, for example, a word or phrase of a specific part of speech obtained by morphological analysis of the browsing log and the posting log. The worker feature acquisition unit 140 may acquire a feature word by a term frequency-inverse document frequency (TF-IDF) method. The worker feature acquisition unit 140 may acquire a feature word by using a dictionary created by the TF-IDF method. In a case where the TF-IDF method is used, the worker feature acquisition unit 140 also refers to the browsing log and the posting log of a user other than the worker 41, and calculates the IDF value of each word. The worker feature acquisition unit 140 separately stores the feature word of the browsing log and the feature word of the posting log of the worker 41 in the worker feature storage unit 150. The worker feature storage unit 150 stores the feature word of the information browsed by the worker 41 and the feature word of the question sentence posted by the worker 41.

The question sentence storage unit 160 stores the question sentences as the target of the annotation work.

The question sentence feature acquisition unit 170 acquires a feature word from each question sentence stored in the question sentence storage unit 160. For example, the question sentence feature acquisition unit 170 performs morphological analysis on a character string in the question sentence, and extracts words of a predetermined part of speech. The question sentence feature acquisition unit 170 may acquire a feature word by the TF-IDF method.

The similarity degree calculation unit 180 calculates the similarity degree between the knowledge of the worker 41 and each question sentence based on the feature word characterizing the field in which the worker 41 has knowledge and the feature word of each question sentence. For example, on the assumption that the posted information more indicates the knowledge of the worker 41 than the browsed information, the similarity degree calculation unit 180 assigns a weight to the feature words included in the posting log, and calculates the similarity degree.

The annotation management unit 190 presents a question as the annotation work target to the worker in descending order from the question sentence at a higher level based on the similarity degree of each of the question sentences as the annotation target. For example, in a case where it is known in advance that the user name “user A” is the worker 41, the annotation management unit 190 acquires and stores in advance the similarity degree of each question sentence to the feature of the worker 41. In a case where an annotation presentation request is acquired from the terminal 31 used by the worker 41, the annotation management unit 190 transmits question sentences in descending order of similarity degree to the terminal 31.

The lines coupling the elements illustrated in FIG. 5 indicate some communication paths, and communication paths other than the communication paths illustrated in FIG. 5 may also be set. The function of each of the elements illustrated in FIG. 5 may be implemented, for example, by causing a computer to execute a program module corresponding to the element.

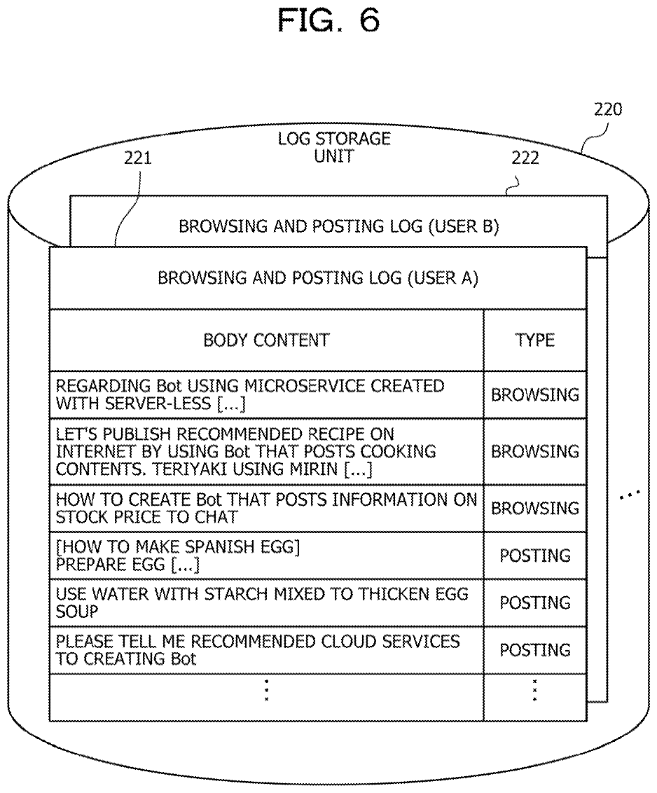

FIG. 6 is a diagram illustrating an example of the browsing and posting log stored in the log storage unit. For example, the log storage unit 220 stores a browsing and posting log 221, 222, or the like for each user. The browsing log and the posting log of the worker 41 having the user name “user A” are included in the browsing and posting log 221.

For example, the browsing and posting log 221 includes the body content of the question sentence browsed or posted by the worker 41. The body content is, for example, a text described in a natural language. A type is set in association with each body content. The type is “browsing” or “posting”. The type “browsing” is set as the body content of the question sentence browsed by the worker 41. The type “posting” is set as the body content of the question sentence posted by the worker 41.

In order to obtain the feature of the knowledge of the worker 41 having the user name “user A”, the annotation server 100 acquires the browsing and posting log 221 of “user A” from the communication server 200. The annotation server 100 acquires a feature word indicating the feature of the knowledge of the worker 41.

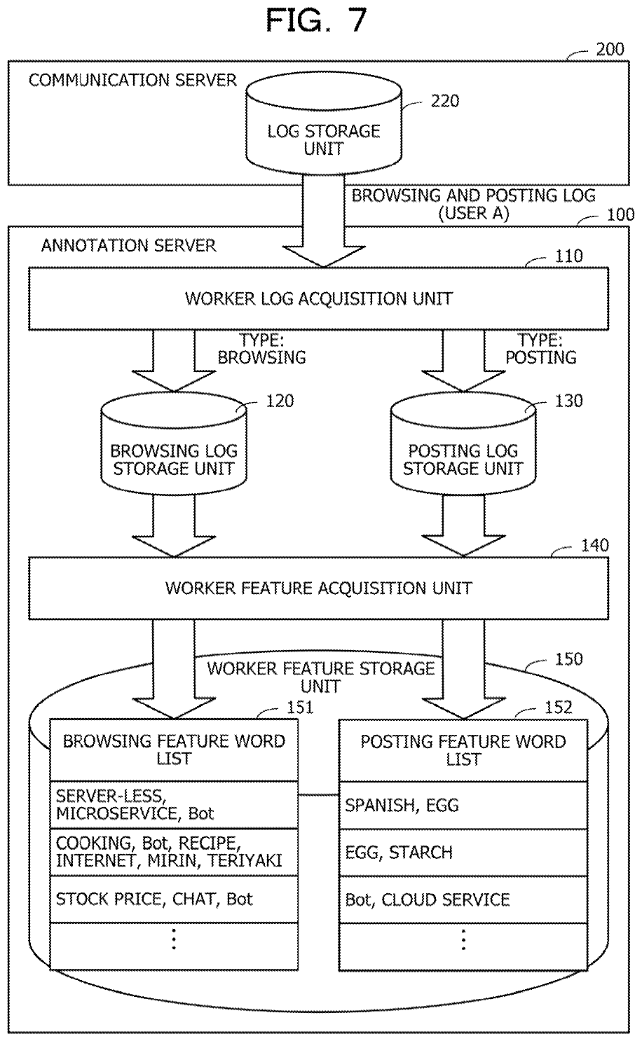

FIG. 7 is a diagram illustrating an example of feature word acquisition processing. The worker log acquisition unit 110 of the annotation server 100 acquires the browsing and posting log 221 of the worker 41 from the log storage unit 220 of the communication server 200. The worker log acquisition unit 110 classifies each body content of the acquired browsing and posting log 221 into the browsing log and the posting log based on the type set for the body content. The worker log acquisition unit 110 stores the body content of the type “browsing” in the browsing log storage unit 120 as the browsing log. The worker log acquisition unit 110 stores the body content of the type “posting” in the posting log storage unit 130 as the posting log.

The worker feature acquisition unit 140 acquires a browsing feature word indicating a field in which the worker 41 is interested, from the browsing log of the worker 41 stored in the browsing log storage unit 120. The worker feature acquisition unit 140 sets the acquired browsing feature word in a browsing feature word list 151 in the worker feature storage unit 150. The worker feature acquisition unit 140 acquires a posting feature word indicating a field in which the worker 41 has knowledge, from the posting log of the worker 41 stored in the posting log storage unit 130. The worker feature acquisition unit 140 sets the acquired posting feature word in a posting feature word list 152 in the worker feature storage unit 150.

The worker feature storage unit 150 stores the browsing feature word list 151 acquired from the browsing log of the worker 41, and the posting feature word list 152 acquired from the posting feature word list 152 of the worker 41.

As described above, the feature word indicating the interest and knowledge of the worker 41 is acquired. Each of the browsing feature word list 151 and the posting feature word list 152 includes many terms in fields in which the worker 41 is interested or fully aware of. In the example illustrated in FIG. 7, there are many terms related to cooking in the browsing feature word list 151 and the posting feature word list 152. Therefore, it may be seen that the worker 41 is interested in the cooking and has knowledge. A large number of egg characters are included in the posting feature word list 152. Therefore, it may be seen that the worker 41 is knowledgeable about the egg dish, for example.

A feature word (question sentence feature word) of each question sentence as the annotation target may be acquired from the question sentence storage unit 160. The question sentence feature word of each question sentence indicates a field to which the content described in the body of the question sentence belongs.

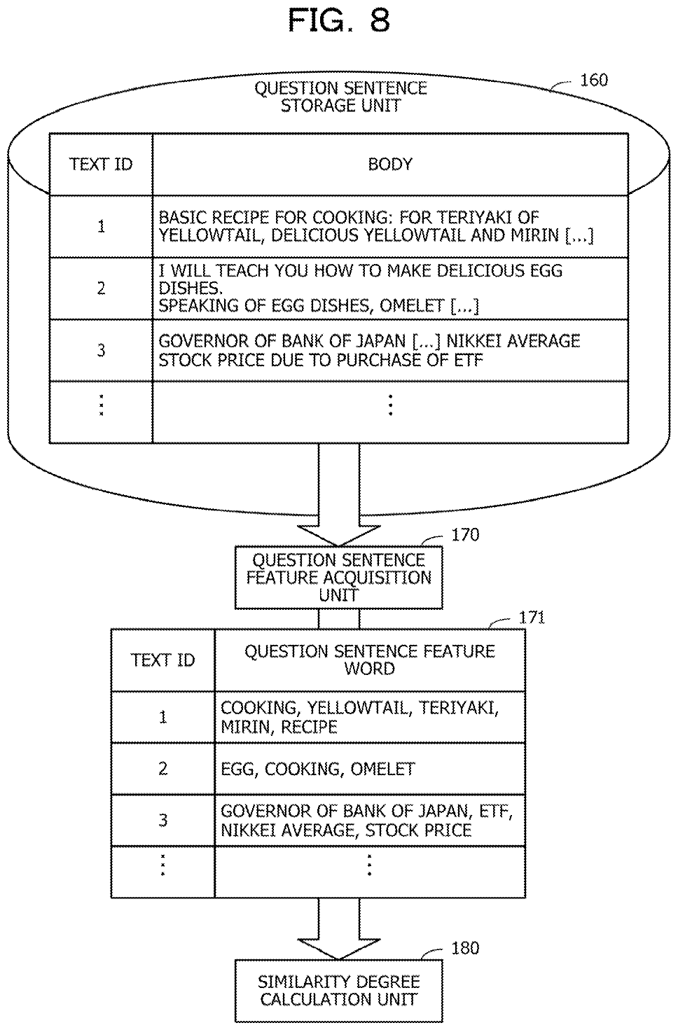

FIG. 8 is a diagram illustrating an example of question sentence feature word acquisition processing. For example, a text described in the body of the question sentence is registered in the question sentence storage unit 160 in association with a text ID that is an identifier of the question sentence. The question sentence feature acquisition unit 170 acquires a question sentence feature word from the body for each question sentence. The question sentence feature acquisition unit 170 outputs a feature word list for each question sentence 171 in which the question sentence feature word acquired from each question sentence is associated with the text ID of the question sentence. The similarity degree calculation unit 180 calculates the similarity degree for each question sentence based on the feature word list for each question sentence 171.

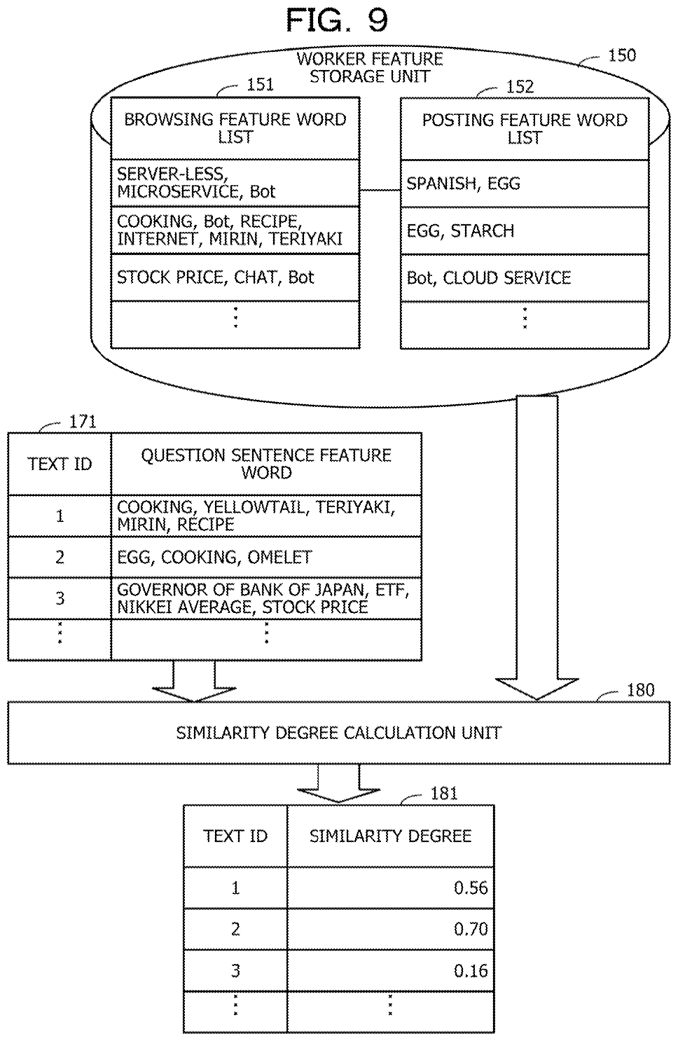

FIG. 9 is a diagram illustrating an example of similarity degree calculation processing. For each question sentence, the similarity degree calculation unit 180 compares the question sentence feature word of the question sentence with the browsing feature word and the posting feature word of the worker 41. The similarity degree calculation unit 180 calculates the similarity degree between the feature of the question sentence and the feature of the field in which the worker 41 has knowledge. At the time of calculating the similarity degree, the similarity degree calculation unit 180 performs weighting such that the similarity degree (posting similarity degree) between the feature word of the question sentence and the posting feature word is reflected more strongly than the similarity degree (browsing similarity degree) between the feature word of the question sentence and the browsing feature word. The similarity degree calculation unit 180 outputs similarity degree data 181 in which the similarity degree obtained for each question sentence is associated with the text ID of the question sentence. The output similarity degree data 181 is transmitted to the annotation management unit 190.

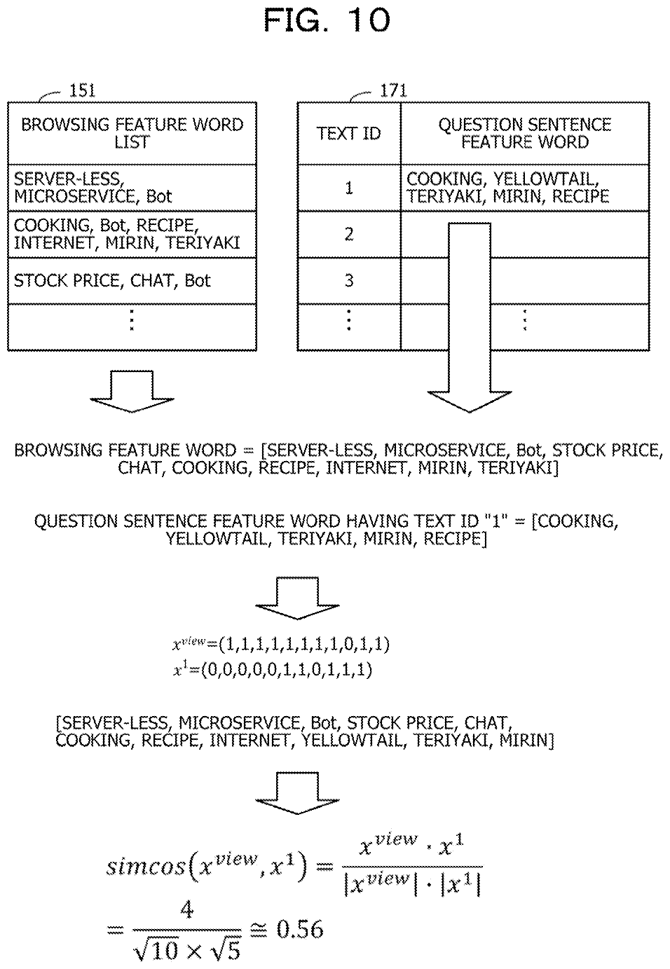

As a method of calculating the similarity degree, for example, a cosine similarity degree may be used. For example, the similarity degree calculation unit 180 calculates the cosine similarity degree (browsing similarity degree) between the feature word of the question sentence and the browsing feature word. The similarity degree calculation unit 180 calculates the cosine similarity degree (posting similarity degree) between the feature word of the question sentence and the posting feature word. Hereinafter, a similarity degree calculation method in a case where the cosine similarity degree is used will be described in detail with reference to FIGS. 10 to 13.

FIG. 10 is a diagram illustrating a first calculation example of the browsing similarity degree. FIG. 10 illustrates a calculation example of the browsing similarity degree between the feature word of the question sentence having the text ID “1” and the browsing feature word list. The similarity degree calculation unit 180 extracts all the browsing feature words from the browsing feature word list 151. In the example illustrated in FIG. 10, the browsing feature words “server-less, microservice, Bot, stock price, chat, cooking, recipe, Internet, mirin, and teriyaki” are extracted. Mirin is a sweet rice wine used in cooking. The similarity degree calculation unit 180 extracts the question sentence feature word having the text ID “1” from the feature word list for each question sentence 171. In the example illustrated in FIG. 10, the question sentence feature words “cooking, yellowtail, teriyaki, mirin, and recipe” having the text ID “1” are extracted.

For the browsing feature word and the question sentence feature word, the similarity degree calculation unit 180 generates vector data indicating the presence or absence of each of the extracted terms. For example, 11 elements are included in the vector data. Each of the elements corresponds to “server-less, microservice, Bot, stock price, chat, cooking, recipe, Internet, yellowtail, teriyaki, and mirin” in order from the left.

Vector data x^{view} indicating the browsing feature word is “x^{view}=(1, 1, 1, 1, 1, 1, 1, 1, 0, 1, 1)”. Vector data x¹ indicating the question sentence feature word having the text ID “1” is “x¹=(0, 0, 0, 0, 0, 1, 1, 0, 1, 1, 1)”. The value “1” of the element of the vector data indicates that the word corresponding to the element is included as the feature word. The value “0” of the element of the vector data indicates that the word corresponding to the element is not included as the feature word. The browsing similarity degree “simcos(x^{view}, x¹)” of the vector data may be calculated by the following expression. simcos(x^{view}, x¹)=(x^{view}·x¹)/(|x^{view}|·|x¹|)

In the example illustrated in FIG. 10, “x^{view}·x¹=4”, “|x^{view}|=10^{1/2}”, and “|x¹|=5^{1/2}” are set. The browsing similarity degree of the question sentence having the text ID “1” is “simcos(x^{view}, x¹)=4/(10^{1/2}×5^{1/2})≈0.56”.

Similarly, the browsing similarity degree is calculated for other question sentences.

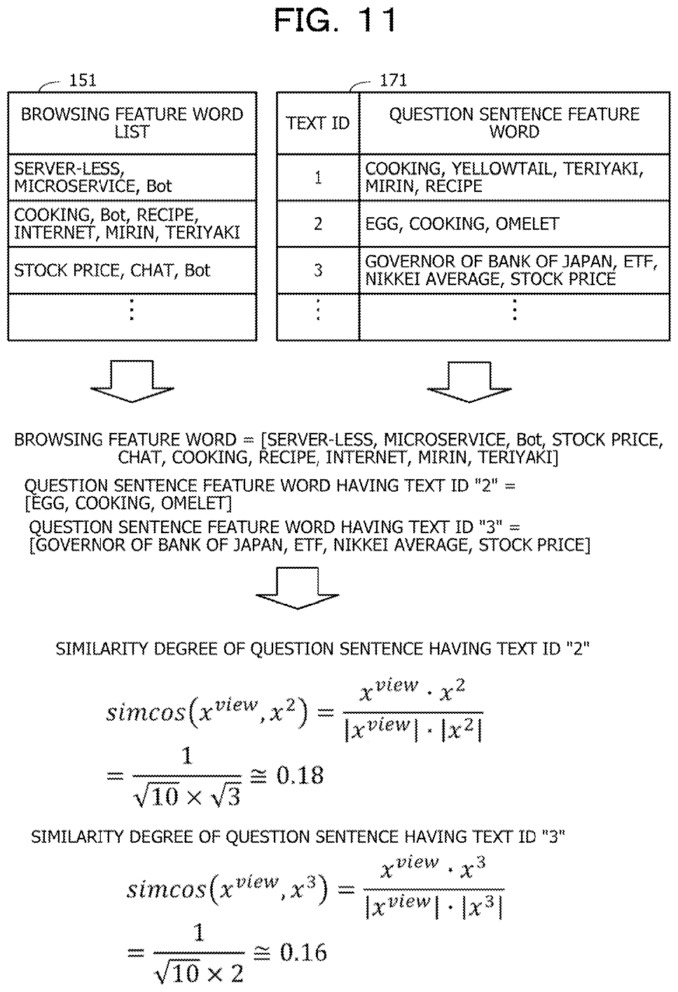

FIG. 11 is a diagram illustrating a second calculation example of the browsing similarity degree. FIG. 11 illustrates a calculation example of the browsing similarity degree of the question sentence having the text ID “2” and a calculation example of the browsing similarity degree of the question sentence having the text ID “3”. The question sentence feature word having the text ID “2” is “egg, cooking, and omelet”. The question sentence feature word having the text ID “3” is “governor of Bank of Japan, exchange traded funds (ETF), Nikkei average, and stock price”.

The browsing similarity degree of the question sentence having the text ID “2” is “simcos(x^{view}, x²)=(x^{view}·x²)/(|x^{view}|·|x²|)=1/(10^{1/2}×3^{1/2})≈0.18”. The browsing similarity degree of the question sentence having the text ID “3” is “simcos(x^{view}, x³)=(x^{view}·x³)/(|x^{view}|·|x³|)=1/(10^{1/2}×2)≈0.16”.

As described above, the browsing similarity degree is calculated for each of the plurality of question sentences. Similarly, the posting similarity degree is calculated for each of the plurality of question sentences.

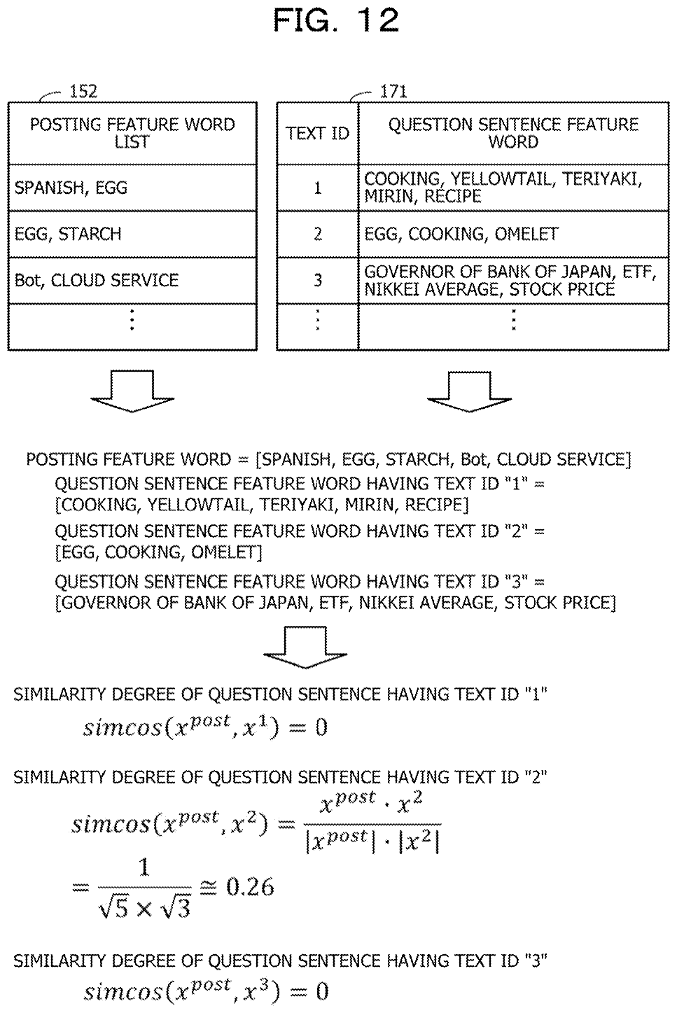

FIG. 12 is a diagram illustrating a calculation example of the posting similarity degree. The similarity degree calculation unit 180 extracts all the posting feature words from the posting feature word list 152. In the example illustrated in FIG. 12, the posting feature words “Spanish, egg, starch, Bot, and cloud service” are extracted. By using vector data x^{post} indicating the posting feature word, the posting similarity degree of each of the plurality of question sentences is calculated.

The posting similarity degree of the question sentence having the text ID “1” is “simcos(x^{post}, x¹)=0”. The posting similarity degree of the question sentence having the text ID “2” is “simcos(x^{post}, x²)=(x^{post}·x²)/(|x^{post}|·|x²|)=1/(5^{1/2}×3^{1/2})≈0.26”. The posting similarity degree of the question sentence having the text ID “3” is “simcos(x^{post}, x³)=0”.

As described above, the posting similarity degree is calculated for each of the plurality of question sentences. For each question sentence, the similarity degree calculation unit 180 calculates the similarity degree to the full knowledge field of the worker 41 based on the browsing similarity degree and the posting similarity degree of the question sentence.

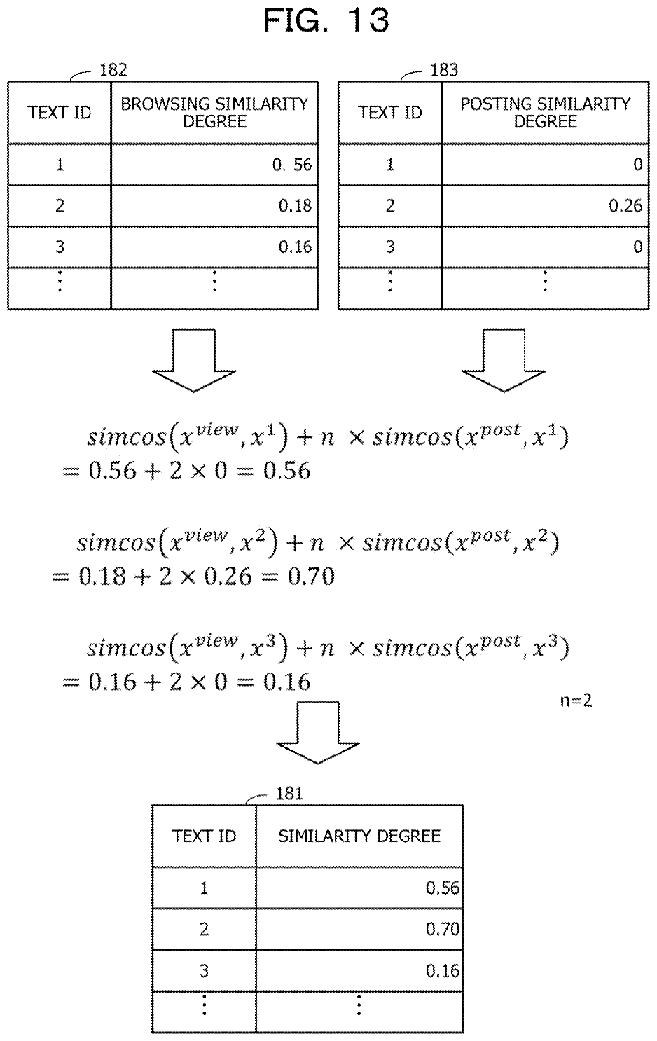

FIG. 13 is a diagram illustrating a calculation example of the similarity degree to the full knowledge field of the worker. For example, the similarity degree calculation unit 180 generates browsing similarity degree data 182 indicating the browsing similarity degree for each question sentence and posting similarity degree data 183 indicating the posting similarity degree for each question sentence based on calculation results of the browsing similarity degree and the posting similarity degree. The similarity degree calculation unit 180 calculates the similarity degree of each question sentence to the full knowledge field of the worker based on the browsing similarity degree data 182 and the posting similarity degree data 183. For example, in a case where the question sentence feature word of a specific text ID is x^{ID}, the similarity degree may be calculated by the following expression. Similarity Degree=simcos(x^{view}, x^{ID})+n×simcos(x^{post}, x^{ID})

Here, n is a coefficient indicating a weight for the posting similarity degree, and is a real number of 1<n. In a case where the coefficient n is “2”, the similarity degree of the question sentence having the text ID “1” is “simcos(x^{view}, x¹)+n×simcos(x^{post}, x¹)=0.56+2×0=0.56”. The similarity degree of the question sentence having the text ID “2” is “simcos(x^{view}, x²)+n×simcos(x^{post}, x²)=0.18+2×0.26=0.70”. The similarity degree of the question sentence having the text ID “3” is “simcos(x^{view}, x³)+n×simcos(x^{post}, x³)=0.16+2×0=0.16”. In a case where the calculation of the similarity degree of each question sentence is completed, the similarity degree calculation unit 180 generates the similarity degree data 181 in which the similarity degree of the question sentence is set in association with the text ID of the question sentence.

As described above, the similarity degree data 181 is generated. The generated similarity degree data 181 is transmitted to the annotation management unit 190. For example, the annotation management unit 190 rearranges the question sentences indicated in the similarity degree data 181 in the order of similarity degree (descending order). The annotation management unit 190 rearranges the rearranged question sentences in the order from a higher level (high similarity degree), and transmits the rearranged question sentences as the question sentence of the annotation target to the terminal 31 used by the worker 41.

By assigning a weight larger than 1 to the posting similarity degree in this manner, it is possible to appropriately calculate the similarity degree between the full knowledge field of the worker 41 and the question sentence, and to display the question sentence in the field that the worker 41 is fully aware of, at a higher level.

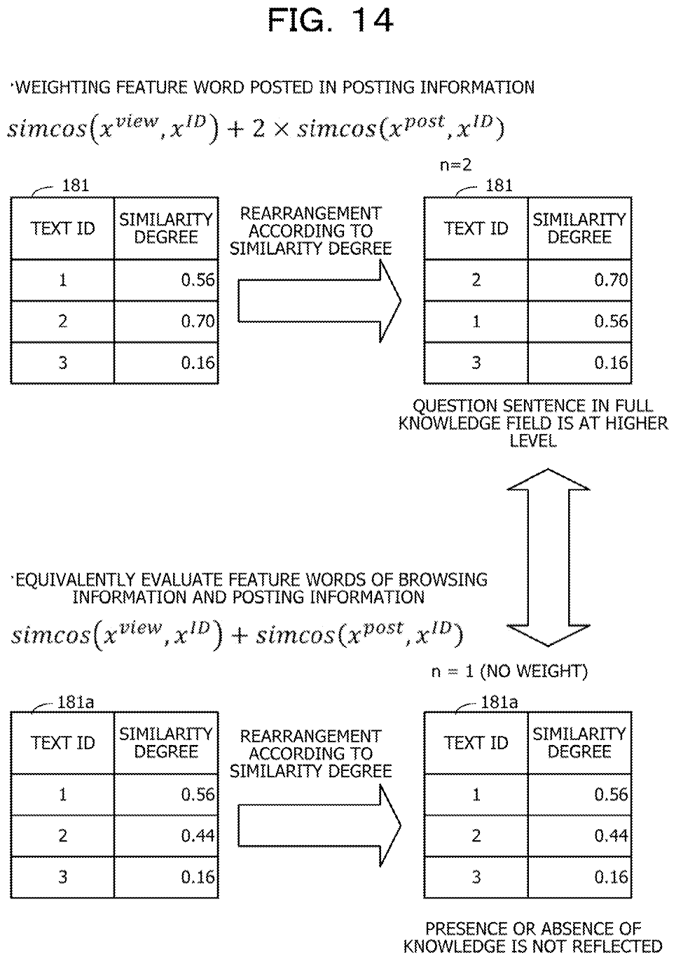

FIG. 14 is a diagram illustrating a difference in the similarity degree between the presence and absence of the weighting. FIG. 14 illustrates a calculation example of the similarity degree of each of the question sentences having text IDs “1” to “3” in a case where the coefficient of the weight of the posting similarity degree is “2” (n=2) and in a case where the coefficient of the weight of the posting similarity degree is “1” (no weight) (n=1). The similarity degree of each question sentence in a case where the weight is “2” is as illustrated in FIG. 13. On the other hand, the similarity degrees of the question sentences in a case where there is no weight are “0.56” for the question sentence having the text ID “1”, “0.44” for the question sentence having the text ID “2”, and “0.16” for the question sentence having the text ID “3”.

In a case where the question sentences indicated in the similarity degree data 181 in a case where weighting is performed are rearranged based on the similarity degree, the order of the text IDs is “2”, “1”, and “3”. On the other hand, in a case where the question sentences indicated in similarity degree data 181a in a case where weighting is not performed are rearranged based on the similarity degree, the order of the text IDs is “1”, “2”, and “3”.

According to the browsing and posting log 221 (refer to FIG. 6) of the worker 41, it is considered that the worker 41 is knowledgeable about cooking, and has rich knowledge about an egg dish, for example. On the other hand, among the descriptions of the body (refer to FIG. 8) of each question sentence in the question sentence storage unit 160, the question sentence having the text ID “2” describes information on an egg dish. As illustrated in FIG. 14, by assigning a weight larger than 1 to the posting similarity degree, the question sentence (text ID “2”) related to a field (egg dish) that the worker 41 is fully aware of is preferentially displayed on the terminal 31 as the annotation target. For example, the question sentence in a field that the worker 41 is fully aware of is presented at a higher level as the annotation target. As a result, the worker 41 may efficiently annotate the question sentence in a field that the worker 41 is fully aware of. On the other hand, in a case where weighting is not performed, information on a field that the worker 41 is particularly knowledgeable about, is not reflected in the presentation order of the question sentences as the annotation target.

Hereinafter, the procedure of annotation support processing will be described in detail with reference to the flowchart.

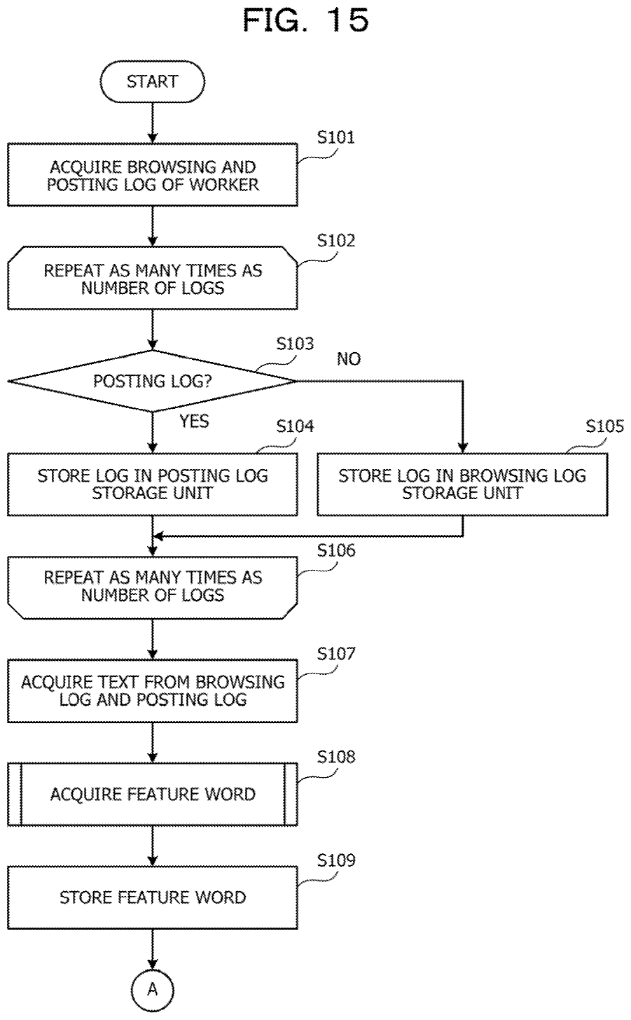

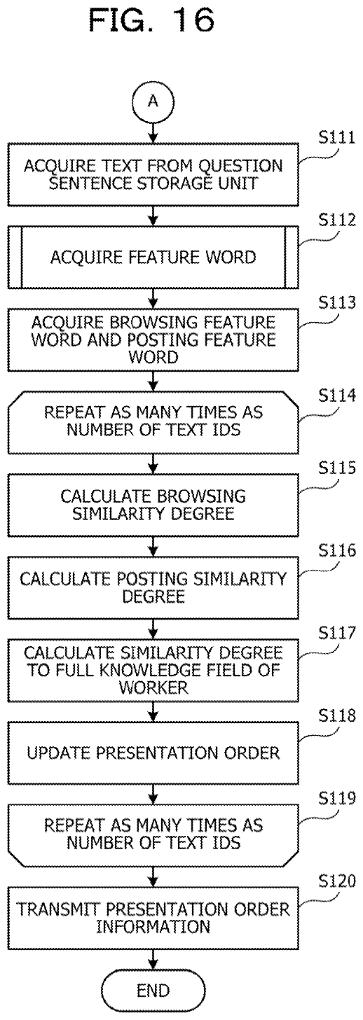

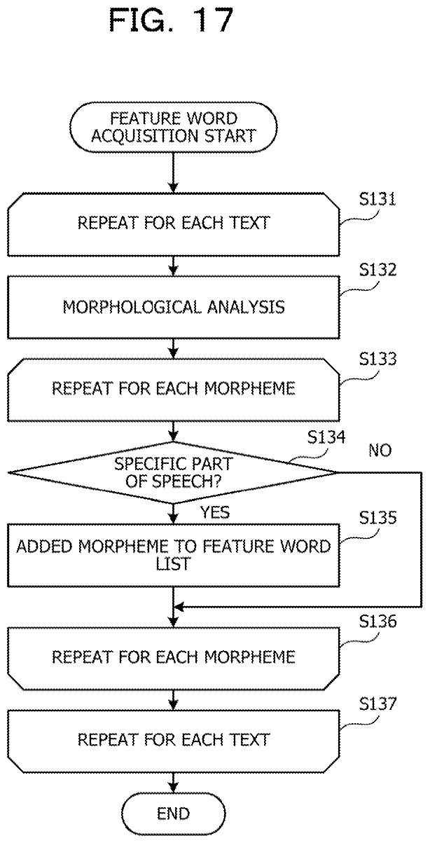

FIG. 15 illustrates a first half of the flowchart illustrating the procedure of the annotation support processing. Hereinafter, processing illustrated in FIG. 15 will be described in the order of step numbers. For example, the annotation support processing is executed at a predetermined date and time. Alternatively, the annotation support processing may be executed in response to a request to acquire a question sentence as the annotation target from the terminal 31 used by the worker 41.

[Step S101] The worker log acquisition unit 110 acquires the browsing and posting log 221 of the worker 41 from the communication server 200.

[Step S102] The worker log acquisition unit 110 repeats the processing of steps S103 to S105 as many times as the number of logs (browsing log or posting log).

[Step S103] The worker log acquisition unit 110 treats the logs in the browsing and posting log 221 as the processing target in order from a higher level, and determines whether or not the processing target log is a posting log. For example, in a case where the type of the processing target log is “posting”, the worker log acquisition unit 110 determines that the log is a posting log. In a case where the log is a posting log, the worker log acquisition unit 110 causes the processing to proceed to step S104. In a case where the log is a browsing log, the worker log acquisition unit 110 causes the processing to proceed to step S105.

[Step S104] The worker log acquisition unit 110 stores the body content of the processing target log in the posting log storage unit 130. Then, the worker log acquisition unit 110 causes the processing to proceed to step S106.

[Step S105] The worker log acquisition unit 110 stores the body content of the processing target log in the browsing log storage unit 120.

[Step S106] In a case where the processing is completed for all the logs in the browsing and posting log 221, the worker log acquisition unit 110 causes the processing to proceed to step S107. In a case where there is an unprocessed log, the worker log acquisition unit 110 repeats the processing of steps S103 to S105.

[Step S107] The worker feature acquisition unit 140 acquires a text indicating the body of each log from the browsing log in the browsing log storage unit 120 and the posting log in the posting log storage unit 130.

[Step S108] The worker feature acquisition unit 140 performs feature word acquisition processing. Details of the feature word acquisition processing will be described later (refer to FIG. 17).

[Step S109] The worker feature acquisition unit 140 stores the feature word acquired in step S108 in the worker feature storage unit 150. For example, the worker feature acquisition unit 140 stores the feature word acquired from the browsing log in the browsing feature word list 151. The worker feature acquisition unit 140 stores the feature word acquired from the posting log in the posting feature word list 152. Then, the worker feature acquisition unit 140 causes the processing to proceed to step S111 (refer to FIG. 16).

FIG. 16 illustrates a latter half of the flowchart illustrating the procedure of the annotation support processing. Hereinafter, the processing illustrated in FIG. 16 will be described in the order of step numbers.

[Step S111] The question sentence feature acquisition unit 170 acquires a text indicating the body of the question sentence from the question sentence storage unit 160.

[Step S112] The question sentence feature acquisition unit 170 performs the feature word acquisition processing. Details of the feature word acquisition processing performed by the question sentence feature acquisition unit 170 are similar to those of the feature word acquisition processing performed by the worker feature acquisition unit 140 in step S108. By the feature word acquisition processing, the question sentence feature acquisition unit 170 generates the feature word list for each question sentence 171 (refer to FIG. 8), and transmits the feature word list for each question sentence 171 to the similarity degree calculation unit 180.

[Step S113] The similarity degree calculation unit 180 acquires the browsing feature word and the posting feature word from the worker feature storage unit 150.

[Step S114] The similarity degree calculation unit 180 repeats the processing of steps S115 to S118 as many times as the number of text IDs.

[Step S115] The similarity degree calculation unit 180 calculates the similarity degree (browsing similarity degree) between the question sentence corresponding to the text ID and the browsing feature word.

[Step S116] The similarity degree calculation unit 180 calculates the similarity degree (posting similarity degree) between the question sentence corresponding to the text ID and the posting feature word.

[Step S117] The similarity degree calculation unit 180 calculates the similarity degree of the question sentence to the full knowledge field of the worker 41 based on the browsing similarity degree and the posting similarity degree. In this case, the similarity degree calculation unit 180 assigns a weight larger than 1 to the posting similarity degree.

[Step S118] The similarity degree calculation unit 180 rearranges the presentation order of the question sentences for which the calculation of the similarity degree is completed, in a descending order based on the similarity degree.

[Step S119] In a case where the processing of steps S115 to S118 is completed for all the text IDs, the similarity degree calculation unit 180 transmits the similarity degree data 181 (refer to FIG. 9) to the annotation management unit 190, and causes the processing to proceed to step S120. In a case where there is an unprocessed text ID, the similarity degree calculation unit 180 repeats the processing of steps S115 to S118.

[Step S120] The annotation management unit 190 sets the presentation order of the question sentences according to the similarity degree, and transmits information indicating the presentation order to the terminal 31 used by the worker 41. Alternatively, the annotation management unit 190 may transmit the information indicating the presentation order after waiting for a request to acquire the question sentence as the annotation target from the terminal 31.

As described above, it is possible to present a question sentence in a field that the worker 41 is fully aware of, as the question sentence of the annotation target, to the worker 41.

Next, the feature word acquisition processing will now be described in detail.

FIG. 17 illustrates a flowchart illustrating an example of a procedure of the feature word acquisition processing. Hereinafter, the processing illustrated in FIG. 17 will be described in the order of step numbers.

[Step S131] The worker feature acquisition unit 140 executes the processing of steps S132 to S136 for each text (body content of the log).

[Step S132] The worker feature acquisition unit 140 performs morphological analysis of the text acquired from the browsing log storage unit 120 or the posting log storage unit 130.

[Step S133] The worker feature acquisition unit 140 executes the processing of steps S134 and S135 for each morpheme extracted in the morphological analysis.

[Step S134] The worker feature acquisition unit 140 determines whether or not the morpheme is a specific part of speech (for example, a noun) designated in advance. In a case where the morpheme is a specific part of speech, the worker feature acquisition unit 140 causes the processing to proceed to step S135. In a case where the morpheme is not a specific part of speech, the worker feature acquisition unit 140 causes the processing to proceed to step S136.

[Step S135] The worker feature acquisition unit 140 adds a processing target morpheme to the feature word list. For example, in a case where the processing target text is the text acquired from the browsing log storage unit 120, the worker feature acquisition unit 140 adds the processing target morpheme to the browsing feature word list 151. In a case where the processing target text is the text acquired from the posting log storage unit 130, the worker feature acquisition unit 140 adds the processing target morpheme to the posting feature word list 152.

[Step S136] In a case where the processing of steps S134 and S135 is completed for all the morphemes extracted from the text being processed, the worker feature acquisition unit 140 causes the processing to proceed to step S137. In a case where there is an unprocessed morpheme, the worker feature acquisition unit 140 repeats the processing of steps S134 and S135.

[Step S137] In a case where the processing of steps S132 to S136 is completed for all the texts acquired from the browsing log storage unit 120 or the posting log storage unit 130, the worker feature acquisition unit 140 ends the feature word acquisition processing. In a case where there is an unprocessed text, the worker feature acquisition unit 140 repeats the processing of steps S132 to S136.

As described above, the feature word indicating the field in which the worker has knowledge is extracted. A procedure of feature word extraction processing (step S112) by the question sentence feature acquisition unit 170 is also similar to that in the flowchart in FIG. 17. However, in the feature word extraction processing by the question sentence feature acquisition unit 170, the processing subject is the question sentence feature acquisition unit 170, and the processing target is the text (body) acquired from the question sentence storage unit 160. In the feature word extraction processing by the question sentence feature acquisition unit 170, the output destination of the feature word of the specific part of speech is the feature word list for each question sentence 171 (refer to FIG. 8).

The terminal 31, which has acquired the information indicating the presentation order of question sentences as the target of the annotation work, displays the question sentences on an annotation work screen, for example.

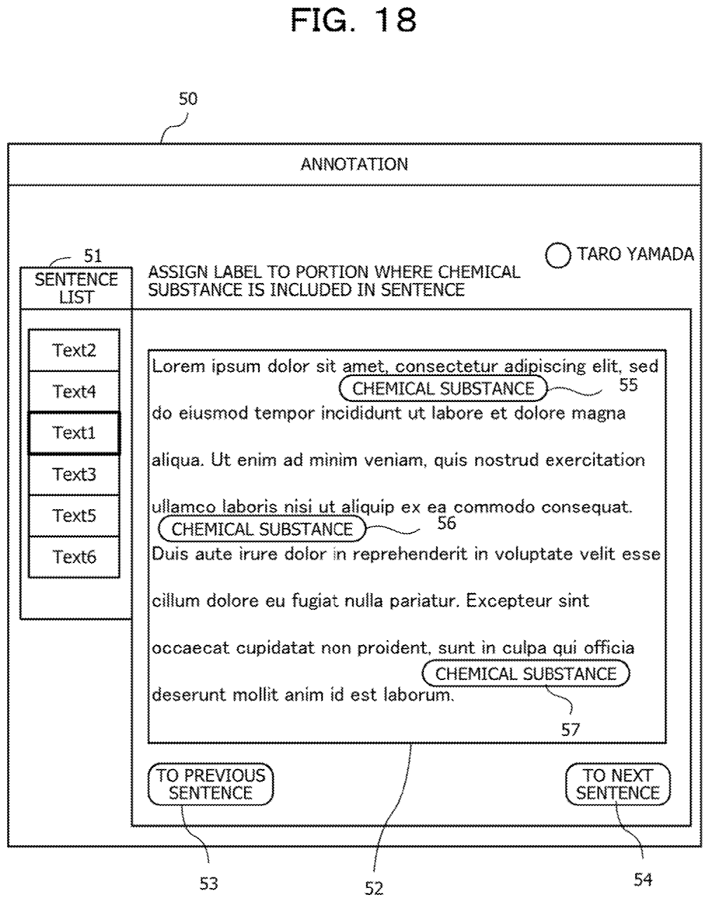

FIG. 18 is a diagram illustrating an example of the annotation work screen. For example, on an annotation work screen 50, a sentence list 51, a text display section 52, and a plurality of buttons 53 and 54 are displayed. Identification information (for example, text ID) of the question sentences is indicated in the sentence list 51 in the presentation order. The worker 41 may select a question sentence to be worked on, from the sentence list 51. The content of the selected question sentence is displayed on the text display section 52. In the text display section 52, labels 55 to 57 indicating chemical substances are displayed beside the word that is designated as a chemical substance by the worker 41.

The button 53 is a button for changing the question sentence displayed on the text display section 52 to a previous sentence (higher-level sentence) in the sentence list 51. In a case where the button 53 is pressed, the display content of the text display section 52 is changed to a question sentence one before the question sentence that is currently displayed on the text display section 52.

The button 54 is a button for changing the question sentence displayed on the text display section 52 to a next sentence (lower-level sentence) in the sentence list 51. In a case where the button 54 is pressed, the display content of the text display section 52 is changed to a question sentence one after the question sentence that is currently displayed on the text display section 52.

The worker 41 reads the text displayed on the text display section 52, and performs an operation of assigning a label to a predetermined portion. In the example in FIG. 18, it is desired to assign a label to a portion indicating the chemical substance.

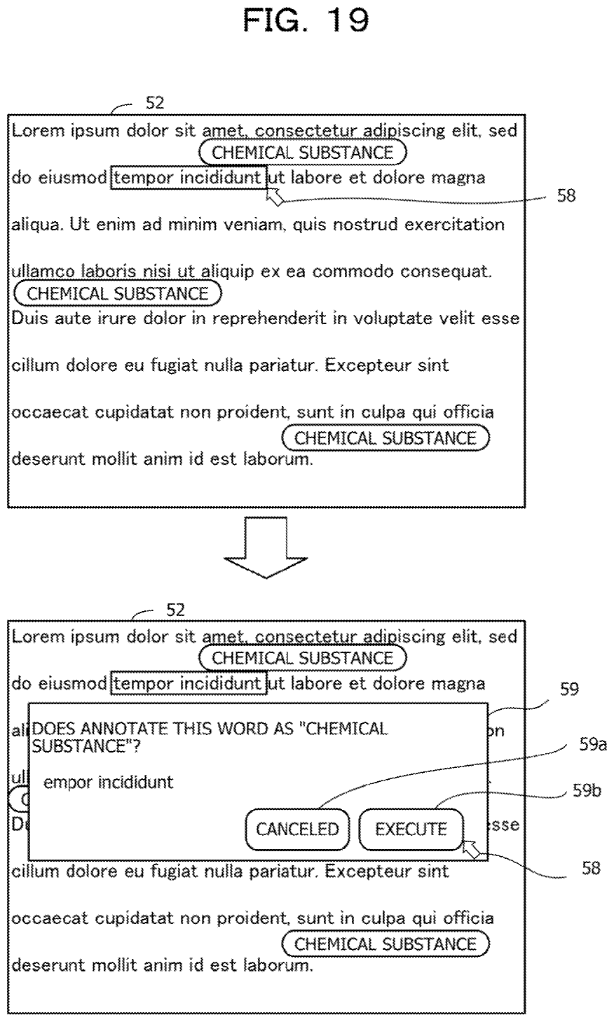

FIG. 19 is a diagram illustrating an example of label assignment processing to a predetermined portion of the question sentence. For example, the worker 41 selects, with a mouse cursor 58, a word to be labeled as a chemical substance. A dialog box 59 is displayed on the screen. In the dialog box 59, the selected word is displayed, and a cancel button 59a and an execution button 59b are displayed. In a case of canceling the assignment of the label to the selected word, the worker 41 presses the cancel button 59a. On the other hand, in a case where there is no error in that the selected word is a chemical substance, the worker 41 presses the execution button 59b. A new label is displayed beside the selected word.

Since the example illustrated in FIG. 19 assumes a case where only one type of label is assigned, selection and confirmation are performed only once. In a case of assigning two or more types of labels, for example, an operation of selecting a label to be assigned is performed first. After the label to be applied is selected, the worker 41 performs an operation of assigning a label as illustrated in FIG. 19. The preselected type of label is assigned to the selected word.

Selecting the type of label to be assigned may be performed later. In this case, the worker 41 selects a word to which a label is to be assigned, and then selects the type of label to be assigned. In order to improve work efficiency, the dialog box 59 may be omitted, and a label may be assigned only by selection with the mouse cursor 58.

In a case where a label is assigned to a word on the annotation work screen 50, the terminal 31 used by the worker 41 transmits a set of information indicating the word and the assigned label to the annotation server 100. In the annotation server 100, the annotation management unit 190 adds the label assigned by the worker 41 to the text on which the annotation work is performed, and stores the text in the question sentence storage unit 160.

As described above, by distinguishing the browsing log and the posting log from each other, assigning a weight to the posting log, and calculating the similarity degree of the question sentence to the field that the worker 41 is fully aware of, it is possible to correctly determine the question sentence having the content similar to the field that the worker is fully aware of. For example, although it is possible to predict a field in which the worker 41 is interested by performing the determination only based on the browsing log, it is difficult to determine how much knowledge the worker 41 has in the field. By contrast, by using the posting log in addition to the browsing log and setting the weight of the posting log to be larger than that of the browsing log, it is possible to correctly determine the field that the worker 41 is fully aware of. As a result, it is possible to correctly present the question sentence in the field that the worker 41 is fully aware of, as the target of the annotation work. The efficiency of the annotation work is improved, and the quality of the work is also improved.

Based on the browsing log and the posting log of the worker 41, it is possible to specify the question sentence having a content similar to the field that the worker is fully aware of, and thus it is possible to rearrange question sentences as the annotation target without comparison with knowledge of users other than the worker 41. For example, the field that the worker 41 is fully aware of may be determined based on an absolute reference instead of a reference relative to other users, and thus the reliability of the determination result is improved.

### Third Embodiment

According to a third embodiment, the posting for a question and the posting for an answer to the Q&A site are distinguished from each other among the postings by the worker 41. For example, depending on the communication tool, there is a case where a poster may perform the posting for a question and the posting for an answer as in the Q&A site. As in the case where the logs of browsing and posting are separated, the posting for a question and the posting for an answer may be distinguished from each other. As compared with a question, the fact that the worker 41 is able to answer may be estimated as having detailed knowledge about the field. Accordingly, by assigning a coefficient indicating a larger weight to the answer in the Q&A site among the posting logs of the worker 41, it is possible to perform more appropriate presentation.

For example, vector data indicating a question feature word is set as x^{question}, and vector data indicating an answer feature word is set as x^{answer_all}. Assuming that vector data of the question sentence feature word of a specific text ID is x^{ID}, a similarity degree to the question sentence in a case where the question and the answer are distinguished from each other may be calculated by the following expression. Similarity Degree=simcos(x^{question}, x^{ID})+n×simcos(x^{answer_all}, x^{ID})

simcos(x^{question}, x^{ID}) is a similarity degree (question similarity degree) between the question feature word and the question sentence feature word. simcos(x^{answer_all}, x^{ID}) is a similarity degree (answer similarity degree) between the answer feature word and the question sentence feature word.

In the Q&A sites, there is a site having a function of determining a good answer (best answer) by selection of a questioner or voting of other browsers. For example, in a case where the answer by the worker 41 gets a high score or is the best answer, it may be estimated that the worker 41 has deeper knowledge than other answerers. Accordingly, in a case where the answer by the worker 41 is the best answer (or gets a high score), it is possible to present a more appropriate question by assigning a coefficient indicating a larger weight to the answer than to other answers.

For example, vector data indicating the answer feature word other than the best answer is set as x^{answer}, and vector data indicating the answer feature word of the best answer is set as x^{best}. Assuming that vector data of the question sentence feature word of a specific text ID is x^{ID}, a similarity degree to the question sentence in a case where a general answer and a best answer are distinguished from each other may be calculated by the following expression. Similarity Degree=simcos(x^{answer}, x^{ID})+n×simcos(x^{best}, x^{ID})

simcos(x^{answer}, x^{ID}) is a similarity degree (general answer similarity degree) between the answer feature word other than the best answer and the question sentence feature word. simcos(x^{best}, x^{ID}) is a similarity degree (best answer similarity degree) between the best answer feature word and the question sentence feature word.

Accordingly, in the system according to the third embodiment, a Q&A system is assumed, appropriate weighting is performed on each of the question similarity degree, the general answer similarity degree, and the best answer similarity degree, and the similarity degree of the question sentence to the field that the worker 41 is fully aware of is obtained. Hereinafter, different points of the third embodiment from those of the second embodiment will be described in detail.

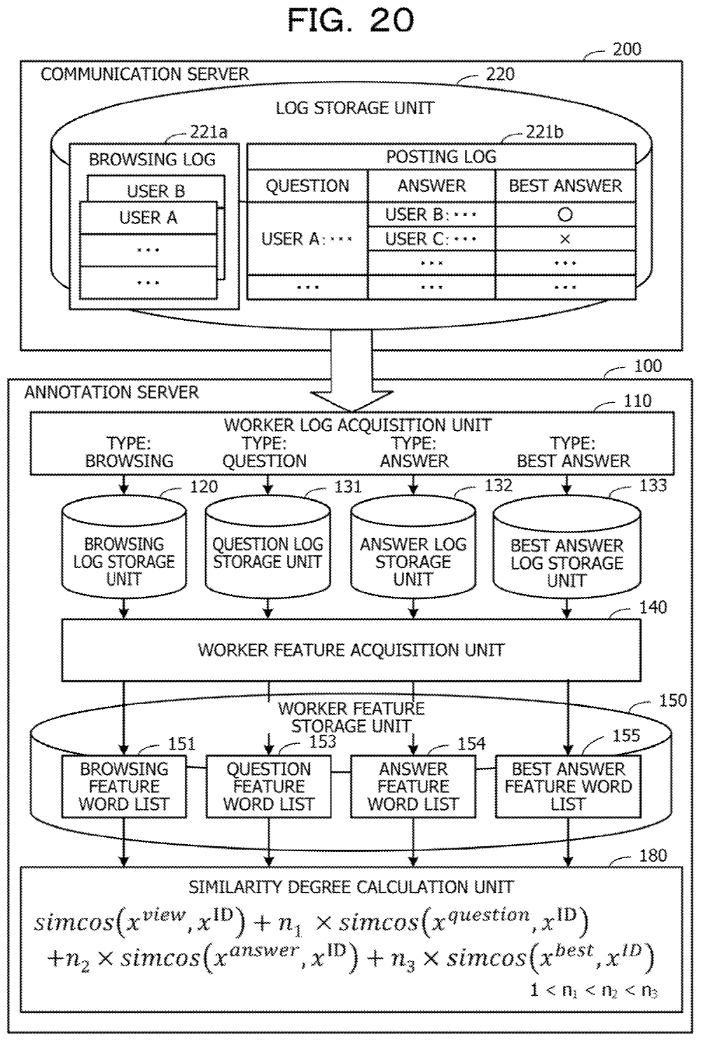

FIG. 20 is a diagram illustrating an example of similarity degree calculation processing using the posting log of the Q&A site. A browsing log 221a and a posting log 221b are stored in the log storage unit 220 of the communication server 200. The browsing log 221a is data indicating the text in the Q&A site browsed by each user. The posting log 221b is data indicating the text for a question or an answer posted by each user to the Q&A site. In the posting log 221b, the text (answer log) indicating one or more answers to a question is stored in association with the text (question log) indicating the posting for the question. A user name of the user who has performed the posting is set in each of the question log and the answer log. A flag indicating whether or not the answer is selected as the best answer is set in the answer log. In the example illustrated in FIG. 20, a circular flag is set in the answer log selected as the best answer.

The worker log acquisition unit 110 of the annotation server 100 acquires logs (the browsing log, the question log, and the answer log) of the worker from the log storage unit 220. In a case where the acquired log is the browsing log, the worker log acquisition unit 110 stores the log in the browsing log storage unit 120. In a case where the acquired log is the question log, the worker log acquisition unit 110 stores the log in a question log storage unit 131. In a case where the acquired log is the answer log and is not the best answer, the worker log acquisition unit 110 stores the log in an answer log storage unit 132. In a case where the acquired log is the answer log and is the best answer, the worker log acquisition unit 110 stores the log in a best answer log storage unit 133.

The worker feature acquisition unit 140 extracts a feature word (browsing feature word) from the browsing log, and registers the feature word in the browsing feature word list 151 in the worker feature storage unit 150. The worker feature acquisition unit 140 extracts a feature word (question feature word) from the question log, and registers the feature word in a question feature word list 153 in the worker feature storage unit 150. The worker feature acquisition unit 140 extracts a feature word (answer feature word) from the answer log, and registers the feature word in an answer feature word list 154 in the worker feature storage unit 150. The worker feature acquisition unit 140 extracts a feature word (best answer feature word) from the best answer log, and registers the feature word in a best answer feature word list 155 in the worker feature storage unit 150.

The similarity degree calculation unit 180 calculates the similarity degree of each question sentence to the field that the worker 41 is fully aware of, based on the browsing similarity degree, the question similarity degree, the general answer similarity degree, and the best answer similarity degree. For example, the similarity degree of the question sentence may be calculated by the following expression. Similarity Degree=simcos(x^{view}, x^{ID}) nix simcos(x^{question}, x^{ID})+n₂×simcos(x^{answer}, x^{ID})+n₃×simcos(x^{best}, x^{ID})

n₁ is a coefficient indicating a weight for the question similarity degree. n₂ is a coefficient indicating a weight for the general answer similarity degree. n₃ is a coefficient indicating a weight for the best answer similarity degree. The coefficients indicating respective weights have a relationship of “1<n₁<n₂<n₃”. By calculating the similarity degree using such an expression, it is possible to present a more appropriate question sentence to the worker 41.

Hereinafter, a procedure of annotation support processing according to the third embodiment will be described in detail with reference to the flowchart.

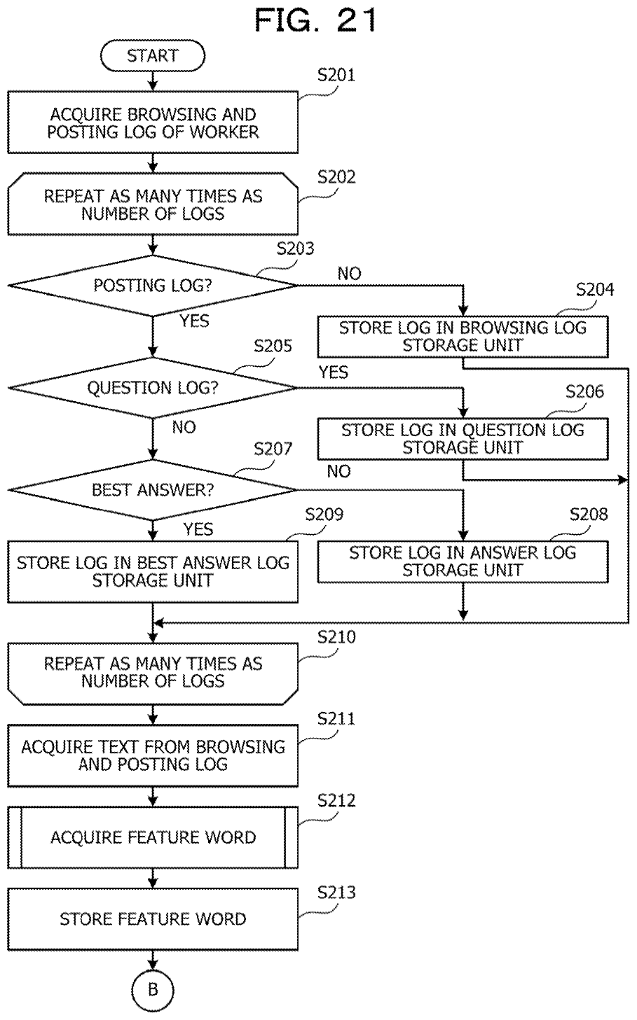

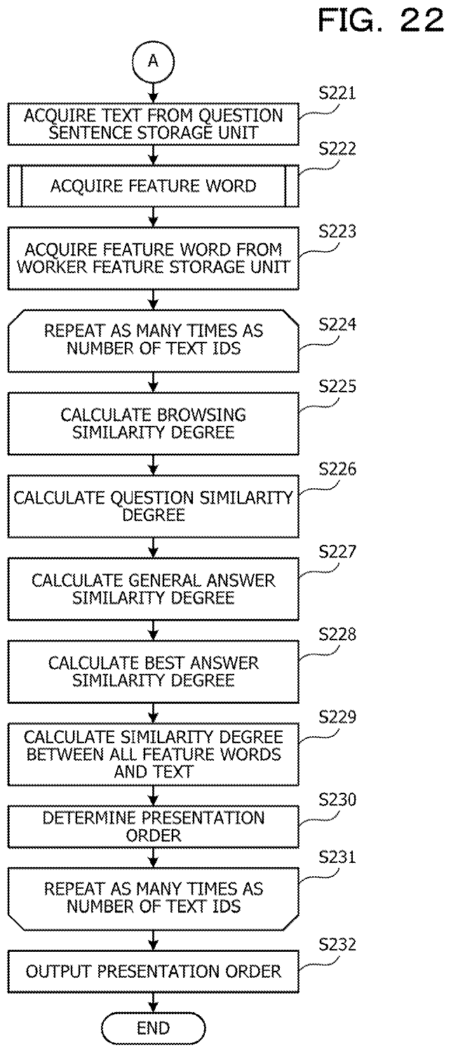

FIG. 21 illustrates a first half of the flowchart illustrating the procedure of the annotation support processing in the third embodiment. Hereinafter, the processing illustrated in FIG. 21 will be described in the order of step numbers.

[Step S201] The worker log acquisition unit 110 acquires the browsing log and the posting log (including the question log and the answer log) of the worker 41 from the communication server 200.

[Step S202] The worker log acquisition unit 110 repeats the processing of steps S203 to S209 as many times as the number of logs (browsing log or posting log).

[Step S203] The worker log acquisition unit 110 determines whether or not the processing target log is a posting log. In a case where the log is a posting log, the worker log acquisition unit 110 causes the processing to proceed to step S205. In a case where the log is a browsing log, the worker log acquisition unit 110 causes the processing to proceed to step S204.

[Step S204] The worker log acquisition unit 110 stores the body content of the processing target log in the browsing log storage unit 120. Then, the worker log acquisition unit 110 causes the processing to proceed to step S210.

[Step S205] The worker log acquisition unit 110 determines whether or not the processing target log is a question log. In a case where the log is a question log, the worker log acquisition unit 110 causes the processing to proceed to step S206. In a case where the log is an answer log, the worker log acquisition unit 110 causes the processing to proceed to step S207.

[Step S206] The worker log acquisition unit 110 stores the body content of the processing target log in the question log storage unit 131. Then, the worker log acquisition unit 110 causes the processing to proceed to step S210.

[Step S207] The worker log acquisition unit 110 determines whether or not the processing target log is a best answer log. For example, in a case where a flag indicating the best answer is set in the answer log, the worker log acquisition unit 110 determines that the answer log is the best answer log. In a case where the log is a best answer log, the worker log acquisition unit 110 causes the processing to proceed to step S209. In a case where the log is a general answer log other than the best answer log, the worker log acquisition unit 110 causes the processing to proceed to step S208.

[Step S208] The worker log acquisition unit 110 stores the body content of the processing target log in the answer log storage unit 132. Then, the worker log acquisition unit 110 causes the processing to proceed to step S210.

[Step S209] The worker log acquisition unit 110 stores the body content of the processing target log in the best answer log storage unit 133.

[Step S210] In a case where the processing is completed for all the acquired logs, the worker log acquisition unit 110 causes the processing to proceed to step S211. In a case where there is an unprocessed log, the worker log acquisition unit 110 repeats the processing of steps S203 to S209.

[Step S211] The worker feature acquisition unit 140 acquires the text indicating the body of each log from the browsing log storage unit 120, the question log storage unit 131, the answer log storage unit 132, and the best answer log storage unit 133.

[Step S212] The worker feature acquisition unit 140 performs the feature word acquisition processing.

[Step S213] The worker feature acquisition unit 140 stores the feature word acquired in step S212 in the worker feature storage unit 150. For example, the worker feature acquisition unit 140 stores the feature word acquired from the browsing log in the browsing feature word list 151. The worker feature acquisition unit 140 stores the feature word acquired from the question log in the question feature word list 153. The worker feature acquisition unit 140 stores the feature word acquired from the answer log in the answer feature word list 154. The worker feature acquisition unit 140 stores the feature word acquired from the best answer log in the best answer feature word list 155. Then, the worker feature acquisition unit 140 causes the processing to proceed to step S221 (refer to FIG. 22).

FIG. 22 illustrates a latter half of the flowchart illustrating the procedure of the annotation support processing in the third embodiment. Hereinafter, the processing illustrated in FIG. 22 will be described in the order of step numbers.

[Step S221] The question sentence feature acquisition unit 170 acquires the text indicating the body of the question sentence from the question sentence storage unit 160.

[Step S222] The question sentence feature acquisition unit 170 performs the feature word acquisition processing on the acquired text. The question sentence feature acquisition unit 170 transmits the feature word list for each question sentence 171 generated by the feature word acquisition processing to the similarity degree calculation unit 180.

[Step S223] The similarity degree calculation unit 180 acquires the browsing feature word, the question feature word, the answer feature word, and the best answer feature word from the worker feature storage unit 150.

[Step S224] The similarity degree calculation unit 180 repeats the processing of steps S225 to S230 as many times as the number of text IDs.

[Step S225] The similarity degree calculation unit 180 calculates the similarity degree (browsing similarity degree) between the question sentence corresponding to the text ID and the browsing feature word.

[Step S226] The similarity degree calculation unit 180 calculates the similarity degree (question similarity degree) between the question sentence corresponding to the text ID and the question feature word.

[Step S227] The similarity degree calculation unit 180 calculates the similarity degree (general answer similarity degree) between the question sentence corresponding to the text ID and the general answer feature word.

[Step S228] The similarity degree calculation unit 180 calculates the similarity degree (best answer similarity degree) between the question sentence corresponding to the text ID and the best answer feature word.

[Step S229] The similarity degree calculation unit 180 calculates the similarity degree of the question sentence to the full knowledge field of the worker 41, based on the browsing similarity degree, the question similarity degree, the general answer similarity degree, and the best answer similarity degree. In this case, the similarity degree calculation unit 180 assigns a weight with the largest value to the best answer similarity degree.

[Step S230] The similarity degree calculation unit 180 rearranges the presentation order of the question sentences for which the calculation of the similarity degree is completed, in a descending order based on the similarity degree.

[Step S231] In a case where the processing of steps S225 to S230 is completed for all the text IDs, the similarity degree calculation unit 180 transmits the similarity degree data 181 (refer to FIG. 9) to the annotation management unit 190, and causes the processing to proceed to step S232. In a case where there is an unprocessed text ID, the similarity degree calculation unit 180 repeats the processing of steps S225 to S230.

[Step S232] The annotation management unit 190 sets the presentation order of the question sentences according to the similarity degree, and transmits information indicating the presentation order to the terminal 31 used by the worker 41.

As described above, it is possible to improve the determination accuracy of the question sentence similar to the field that the worker 41 is fully aware of, by effectively using the posted content in the Q&A site by the worker 41.

### OTHER EMBODIMENTS

Although the cosine similarity degree is used for the calculation of the similarity degree in the second embodiment, the similarity degree may be obtained by another method. For example, a value such as a Jaccard coefficient or a Dice coefficient may be used as the similarity degree. For example, in a case where there are sets A and B, the Jaccard coefficient J(A, B) is represented by the following expression. J(A, B)=|A∩B|/|A∪B|

However, in a case where both the sets A and B are empty sets, J(A, B)=1 is set. For example, it is assumed that the browsing feature words are “server-less, microservice, Bot, stock price, chat, cooking, recipe, Internet, mirin, and teriyaki”, and the question sentence feature words having the text ID “1” are “cooking, yellowtail, teriyaki, mirin, and recipe”. In a case where a list of the browsing feature words is set as a set A and a list of the question sentence feature words is set as a set B, the Jaccard coefficient “J (browsing, text)=3/11” between the browsing feature word and the question sentence feature word is obtained.

Although the embodiments are exemplified hereinabove, the configurations of the units described in the embodiments may be replaced with others having similar functions. Arbitrary other component or step may be added. Arbitrary two or more configurations (features) of the embodiments described above may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a control program for causing a computer to execute processing comprising:
acquiring browsing feature information indicating a feature of a browsed sentence from browsed data indicating the browsed sentence that is browsed by a user;
acquiring posting feature information indicating a feature of a posted sentence from posted data indicating the posted sentence that is posted by the user;
acquiring target feature information indicating a feature of a target sentence from each of a plurality of target sentences as a processing target;
calculating a similarity degree of the target feature information to a set of the browsing feature information and the posting feature information by assigning a larger weight to the posting feature information than to the browsing feature information for each of the plurality of target sentences; and
determining a priority of each of the plurality of target sentences to be presented to the user as the processing target, based on the similarity degree of each of the plurality of target sentences.

2. The non-transitory computer-readable recording medium according to claim 1, wherein
the calculating of the similarity degree includes
calculating a first similarity degree indicating a similarity degree between the target feature information and the browsing feature information is calculated, a second similarity degree indicating a similarity degree between the target feature information and the posting feature information, and
setting, as the similarity degree of the target sentence, a sum of a value obtained by multiplying the second similarity degree by a coefficient indicating a weight and the first similarity degree.

3. The non-transitory computer-readable recording medium according to claim 2, wherein
the acquiring of the browsing feature information includes generating the browsing feature information including a feature word or phrase included in the browsed sentence,
the acquiring of the posting feature information includes
generating the posting feature information including a feature word or phrase included in the posted sentence,
the acquiring of the target feature information includes
generating the target feature information including a feature word or phrase included in the target sentence,
the calculating of the first similarity degree includes
calculating the first similarity degree based on commonality of a word or phrase included in the target feature information and the browsing feature information, and
the calculating of the second similarity degree includes
calculating the second similarity degree based on commonality of a word or phrase included in the target feature information and the posting feature information.

4. The non-transitory computer-readable recording medium according to claim 1, wherein
the acquiring of the posting feature information includes
classifying the posted sentence into a first posted sentence for positing a question and a second posted sentence for posting an answer, and
acquiring first posting feature information indicating a feature of the first posted sentence and second posting feature information indicating a feature of the second posted sentence, and
the calculating of the similarity degree includes
calculating the similarity degree of the target sentence by assigning a larger weight to the second posting feature information than to the first posting feature information.

5. The non-transitory computer-readable recording medium according to claim 1, wherein
the acquiring of the posting feature information includes
classifying the posted sentence for posting an answer to a question into a third posted sentence for posting an answer that is not selected as a good answer and a fourth posted sentence for posting an answer selected as a good answer, and
acquiring third posting feature information indicating a feature of the third posted sentence and fourth posting feature information indicating a feature of the fourth posted sentence, and
the calculating of the similarity degree includes
calculating the similarity degree of the target sentence by assigning a larger weight to the fourth posting feature information than to the third posting feature information.

6. A control method implemented by a computer, the control method comprising:
acquiring, by a processor circuit of the computer, from a memory pf the computer, browsing feature information indicating a feature of a browsed sentence from browsed data indicating the browsed sentence that is browsed by a user;
acquiring, by the processor circuit of the computer, from the memory of the computer, posting feature information indicating a feature of a posted sentence from posted data indicating the posted sentence that is posted by the user;
acquiring, by the processor circuit of the computer, from the memory of the computer, target feature information indicating a feature of a target sentence from each of a plurality of target sentences as a processing target;
calculating, by the processor circuit of the computer, a similarity degree of the target feature information to a set of the browsing feature information and the posting feature information by assigning a larger weight to the posting feature information than to the browsing feature information for each of the plurality of target sentences; and
determining, by the processor circuit of the computer, a priority of each of the plurality of target sentences to be presented to the user as the processing target, based on the similarity degree of each of the plurality of target sentences.

7. An information processing apparatus comprising:
a memory; and
a processor coupled to the memory, the processor being configured to perform processing including:
acquiring browsing feature information indicating a feature of a browsed sentence from browsed data indicating the browsed sentence that is browsed by a user;
acquiring posting feature information indicating a feature of a posted sentence from posted data indicating the posted sentence that is posted by the user;
acquiring target feature information indicating a feature of a target sentence from each of a plurality of target sentences as a processing target;
calculating a similarity degree of the target feature information to a set of the browsing feature information and the posting feature information by assigning a larger weight to the posting feature information than to the browsing feature information for each of the plurality of target sentences; and
determining a priority of each of the plurality of target sentences to be presented to the user as the processing target, based on the similarity degree of each of the plurality of target sentences.
